(19) United States
(12) Patent Application Publication
(10) Pub. No.: US 2023/0177603 A1
(43) Pub. Date: Jun. 8, 2023

(54) SYSTEMS AND METHODS FOR ENHANCED COMPUTER LOGIC PROCESSING OF MORTGAGE LOAN ORIGINATIONS

(71) Applicants: Joel A. HORN, Lone Tree, CO (US); Courtney L. HORN, Lone Tree, CO (US)

(72) Inventors: Joel A. HORN, Lone Tree, CO (US); Courtney L. HORN, Lone Tree, CO (US)

(21) Appl. No.: 18/060,911

(22) Filed: Dec. 1, 2022

Related U.S. Application Data
(60) Provisional application No. 63/264,930, filed on Dec. 3, 2021.

(51) Int. Cl. G06Q 40/03; G06Q 10/10

(52) U.S. Cl. CPC G06Q 40/03; G06Q 10/103

(57) ABSTRACT

A computing system for transforming and improving the processing of information and records data related to real property loans includes a Game Plan module, the Game Plan module including code fixed in a tangible medium, the game plan module including code for data fields, the data fields grouped according to a loan officer and packaging manager, the Game Plan module including code for a scheduling system for scheduling activities related to the data fields, the Game Plan further including code for presenting customized interfaces to the loan officer and the packaging manager according to the activities for collecting information in the data fields, and including code for transforming the information in the data fields in order to prepare them for loan processing for a location of real property, upon advancement by the loan officer and the packaging manager.

### CROSS REFERENCE TO RELATED APPLICATIONS

This application is a continuation and claims the benefit of U.S. Provisional Application No. 63/264,930 filed Dec. 3, 2021. This application is hereby incorporated by reference.

### BACKGROUND

Mortgage loan origination is a highly competitive business that forms the backbone of US homeownership. Computing systems for managing mortgage origination utilize non-optimal data processing techniques and provide non-optimized data presentation and process flow. This costs significant man hours and, in some cases, may result in the loss of business. Disconnection and dislocation of the overall mortgage loan origination, closing and post-closing process may provide for further delays. Additionally, multiple processes and technologies are often spread across disparate platforms. Even small savings in processing efficiency, can yield significant savings for businesses in the mortgage loan origination space. Therefore, a system that can provide for optimal data processing techniques and improved data presentation and process flow can improve profits.

### BRIEF SUMMARY

In one embodiment, a computing system for transforming and improving the processing of information and records data related to real property loans includes a Game Plan module, the Game Plan module including code fixed in a tangible medium, the game plan module including code for data fields, the data fields grouped according to a loan officer and packaging manager, the Game Plan module including code for a scheduling system for scheduling activities related to the data fields, the Game Plan further including code for presenting customized interfaces to the loan officer and the packaging manager according to the activities for collecting information in the data fields, and including code for transforming the information in the data fields in order to prepare them for loan processing for a location of real property, upon advancement by the loan officer and the packaging manager. In one alternative, the system further includes a Rules Engine module, the Rules Engine module including code fixed in a tangible medium for modifying ability of the loan officer and the packaging manager to perform the advancement. In another alternative, the customized interfaces include an active loan interface and a prospective loan interface for the loan officer. Alternatively, the customized interfaces include an active loan interface and a prospective loan interface for the packaging manager. In another alternative, the Rules Engine module includes a pricing engine that defines the fee on services. Alternatively, the services include a lender fee and an appraisal fee. In one alternative, the Rules Engine module includes a calendar engine, which provides for needed response times for the collection of portions of the information. In another alternative, the Rules Engine module includes PPE rules (product pricing engine) and CERF rules (credit, employment, rules, funds) and the PPE rules include basis eligibility rules for the borrower and the CERF rules include credit check rules, employment verification rules, pricing rules, and funds verification. Alternatively, the system further includes a global manager interface, the global manager interface, providing a plurality of system views, include a loan officer view, a packaging manager view, a loan administrator view, and closer/funder view. In another alternative, each of the plurality of system views is separately accessible by a corresponding user.

In one embodiment, a method for transforming and improving the processing of information and records data related to real property loans includes providing a Game Plan module, the Game Plan module including code fixed in a tangible medium, the game plan module including code for data fields, the data fields grouped according to a loan officer and packaging office. The method further includes scheduling activities related to the data fields, the Game Plan module including code for a scheduling system performing the scheduling; presenting customized interfaces to the loan officer and the packaging manager according to the activities for collecting information in the data fields. The method further includes transforming the information in the data fields in order to prepare them for loan processing for a location of real property, upon advancement by the loan officer and the packaging manager. Alternatively, the method further includes modifying ability of the loan officer and the packaging manager to perform the advancement with a Rules Engine module. In one alternative, the customized interfaces include an active loan interface and a prospective loan interface for the loan officer. In another alternative, the customized interfaces include an active loan interface and a prospective loan interface for the packaging manager. Alternatively, the Rules Engine module includes a pricing engine that defines the fee on services. In another alternative, the services include a lender fee and an appraisal fee. Alternatively, the Rules Engine module includes a calendar engine, which provides for needed response times for the collection of portions of the information. In another alternative, the Rules Engine module includes PPE rules (product pricing engine) and CERF rules (credit, employment, rules, funds) and the PPE rules include basis eligibility rules for the borrower and the CERF rules include credit check rules, employment verification rules, pricing rules, and funds verification. Alternatively, the method further includes providing a global manager interface, the global manager interface providing a plurality of system views, include a loan officer view, a packaging manager view, a loan administrator view, and closer/funder view. Alternatively, each of the plurality of system views is separately accessible by a corresponding user.

In one embodiment, a non-transitory digital storage medium having a computer program stored thereon to perform a method for transforming and improving the processing of information and records data related to real property loans includes providing a Game Plan module, the Game Plan module including code fixed in a tangible medium, the game plan module including code for data fields, the data fields grouped according to a loan officer and packaging office. The method further includes scheduling activities related to the data fields, the Game Plan module including code for a scheduling system performing the scheduling; presenting customized interfaces to the loan officer and the packaging manager according to the activities for collecting information in the data fields. The method further includes transforming the information in the data fields in order to prepare them for loan processing for a location of real property, upon advancement by the loan officer and the packaging manager. Alternatively, the method further includes modifying ability of the loan officer and the packaging manager to perform the advancement with a Rules Engine module. In one alternative, the customized interfaces include an active loan interface and a prospective loan interface for the loan officer.

### BRIEF DESCRIPTION OF THE FIGURES

FIGS. 1-A through 1-C shows one embodiment of a use-case diagram for Brevity administrators;

FIGS. 2-A through 2-C shows an embodiment of a use-case diagram for global or branch managers;

FIG. 3, shows an embodiment of a use-case for the Loan Officer;

FIG. 4 shows an embodiment of a similar use-case for the Loan Administrator;

FIG. 5 shows an embodiment of a use-case for the Packaging Manager;

FIG. 6 shows an embodiment of a use-case for the Closer/Funder;

FIG. 7 shows an embodiment of an interface for a Loan Officer;

FIG. 8 shows one example of an interface for loan applications;

FIG. 9 shows an example of various rate pricing;

FIG. 10 shows one embodiment of the preapproval stage interface;

FIG. 11 shows one embodiment of an interface for CERF suspense;

FIG. 12 shows one embodiment of an interface for pre-approval request;

FIGS. 13 and 14 show an example of the interfaces for moving a loan to a dormant state;

FIG. 15 shows one embodiment of a databank interface;

FIG. 16 shows an embodiment of an upload mechanism for third party documents;

FIG. 17 shows an embodiment of how a user can filter a databank

FIG. 18 shows an embodiment of an interface for the loan officer to communicate with LA using the functionality Request LA;

FIG. 19 shows one embodiment of an agent detail interface;

FIG. 20 shows an embodiment of an interface for adding an agent;

FIG. 21 an embodiment of an interface for saving an agent to be assigned to future loans;

FIG. 22 shows one embodiment of the eSign platform;

FIG. 23 shows an embodiment of the corresponding interface for eSignature;

FIG. 24 shows an example of an email requesting eSignature;

FIG. 25 shows an example of such an interface for a databank;

FIGS. 26 and 27 shown an example of an interface for loan guides;

FIG. 28 shows an example of such an interface for creating a data export from Brevity;

FIG. 29 shows an example of a data export from Brevity;

FIG. 30 shows an example of a repository interface;

FIGS. 31 and 32 show an example of an interface for assignment of team members to projects;

FIG. 33 shows an example of an interface for whether there are any open validations on the loan the validations;

FIG. 34 shows an example of completing validations;

FIG. 35 shows an example of revising borrower information;

FIG. 36 shows an embodiment of an active loans tab;

FIG. 37 shows an example of a Loan Officer selecting an active loan;

FIG. 38 shows an example of a refinance loan type interface;

FIG. 39 shows an example of an interface for reviewing the documentation in the databank;

FIG. 40 shows an example of a loan submission interface;

FIG. 41 shows an example of a calendar screen;

FIG. 43 shows an example of a pricing screen for Brevity;

FIG. 44 shows an example of an amortization schedule for Brevity;

FIG. 45 and FIG. 46 show an example of a fee detail for Brevity;

FIG. 47 shows an example of a data validation screen for Brevity;

FIG. 49 shows an example of an interface for scenarios where the user used multiple addresses for credit reporting;

FIG. 50 shows an example of an additional interface whereby a record may be deleted;

FIG. 51 shows an example of an interface for the upload of borrow IDs;

FIG. 52 shows an example of a final summary screen for Brevity;

FIG. 53 shows an example of a pricing timeout interface; and

FIG. 54 shows an example of the pricing dynamics definitions.

### DETAILED DESCRIPTION

Certain terminology is used herein for convenience only and is not to be taken as a limitation on the embodiments of the systems and methods Enhanced Computer Logic Processing of Mortgage Loan Originations (“Brevity”). In some embodiments, Brevity provides for a web-based mortgage loan origination system utilized to support the loan origination, processing, loan administration, underwriting, closing, funding, post-closing, borrower interaction and general management of the mortgage loan process. Embodiments of Brevity provide for a multi-user and cross-functional platform that provides a system for all facets of the mortgage loan origination and closing process. In some embodiments, the platform's technology is mapped to support a specific process and flow that provides for ‘best practice’ for the fulfillment of mortgage origination.

In some embodiments, Brevity provides for the elimination of disconnection and dislocation of the overall mortgage loan origination, closing and post-closing process. Brevity may provide of the consolidation of multiple processes and technologies into one consistent and organized platform. In some embodiments, Brevity reduces redundant systems, data errors and improves overall loan salability quality. Additionally, Brevity's ‘flow’ of the process provides a sequenced loan file management schematic. Some configurations of Brevity provide for the ability for priority alert management and loan level process monitoring. This may solve industry wide issues of inconsistent loan flow management.

In some embodiments, Brevity provides an overall process map (page by page) of the full mortgage loan origination life cycle. This process map manages the flow of a mortgage loan (client) for each specific component throughout the loan life cycle. The system has three dominant engines that the mortgage flow interacts with: Calendar Engine, Mortgage Pricing & Availability Rules Engine and Underwriting Supporting document Rules engine. The Calendar Engine controls specific user task priority, deadline management, loan date conflicts, compliance deadlines and general system time congruency. The Mortgage Pricing & Availability Rules Engine controls the pricing dynamics and lender/investor (aggregator) price offering interaction. The Underwriting Supporting Document Rules engine (named as the ‘Databank’) controls the needed items required to support the approval and sale of the mortgage loan into the secondary market. Brevity's unique proposition is the specific flow (page by page map) for each user (Loan Originator, Loan Administrator, Packaging Manager, Closer/Funder, Post Closer-CAD, System Admin, Global Manager and Branch Manager) in conjunction with these three engines, etc. IE., the technology is the specific (best practice) process and the flow of the user interaction, etc.

The significant benefits include reduction in duplication of processes, elimination of cross-departmental redundancy, lower processing costs, lower error rate, improved data quality, reduction in compliance failures and faster closing timelines. Additionally, better loan process clarity improves system wide business intelligence. Providing lower risk to management when closing (and owning) mortgage loans as a correspondent mortgage lender.

In many embodiments, Brevity provides multiple types of users access and interaction within the same system. These entities include the system administrator, the global manager, the branch manager, the loan officer, the loan administrator, the packaging manager, and the closer/funder. One of the functions of embodiments of Brevity is allowing control and interaction between at least some of these entities in a seamless fashion.

In many scenarios, an objective of Brevity is to streamline the loan processing system and allow for ready packaging of loans. In many embodiments, this is done via the creation of a Game Plan. The Game Plan is an efficient data structure that stretches across the purview of multiple actors in the Brevity system and thereby increases processing efficiencies by creating a single data file for each user, that is touched and distributed throughout the system and those that interact with it.

Additionally, the Game Plan operates within a Rules Engine. The Rules Engine includes rules for pricing, underwriting, and credit, as well as pricing and calendaring. Based on this, the Game Plan operates under the limits set by the Rules Engine, providing for more efficient data processing.

For example, in many embodiments, a loan officer, a loan administrator, a packaging manager, and a closer funder may all have a Game Plan for processing. This process may be overseen by a Global Manager. In such a scenario, the loan officers and loan administrators may have two sets of game plans, one for active loans and one for prospective loans. Similarly, the packaging manager may have two sets of Game Plans, one for active loans and one for prospective loans. In such a scenario, the Game Plans can function in an overlapping and simultaneous manner. Through such a system, information is shared for each borrower's game plan. Essentially, the system allows for virtually obtaining of borrows by loan officers and preparation for packaging by the packaging managers. In some embodiments, the Game Plan is basically a date schedule shared between all of the users that unify their action and share information in a seamless fashion.

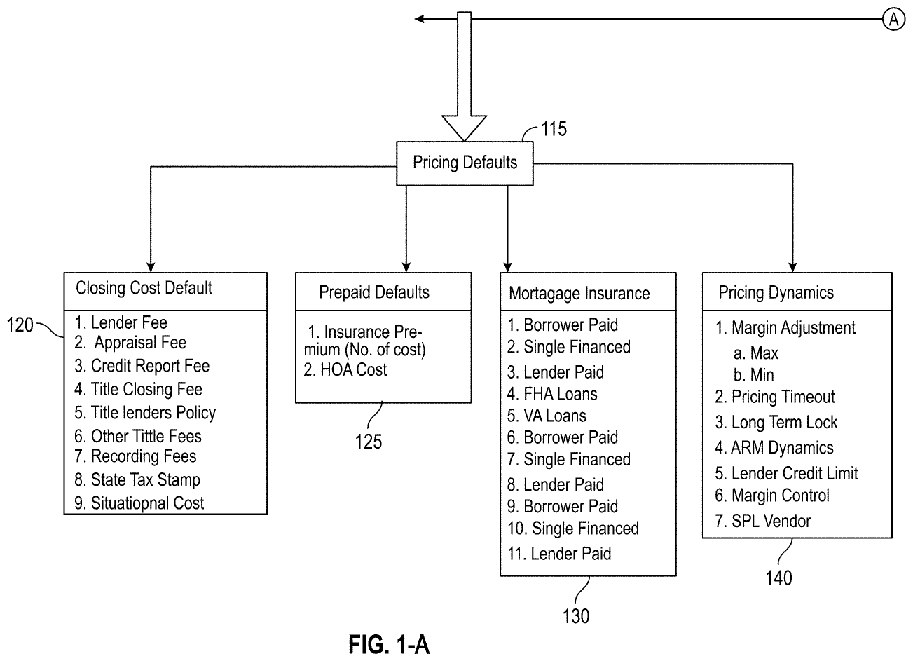

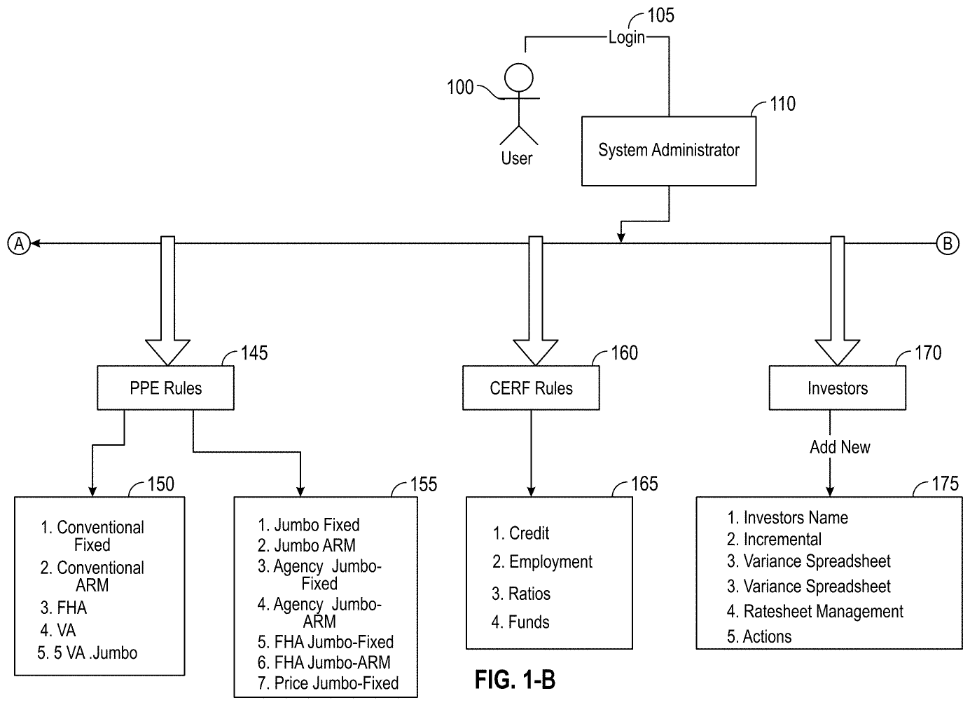

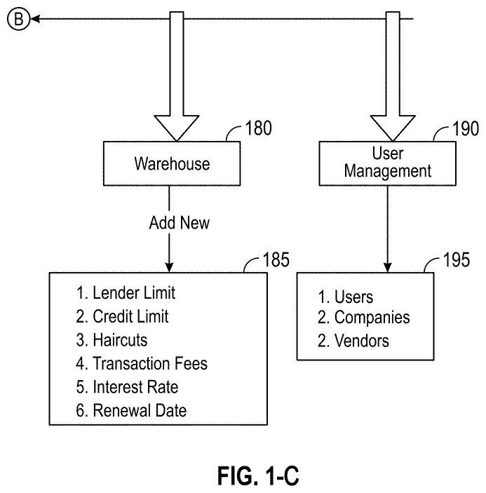

FIGS. 1-A through 1-C show one embodiment of a use-case diagram for Brevity administrators. Generally, the diagram shown corresponds approximately to UML (uniform modeling language). As shown in FIGS. 1-A through 1-C a user 100 may log 105 into Brevity as a system administrator 110. The system administrator has access to a variety of modules that may provided various interfaces. For instance, the system administrator may access a pricing defaults 115. In this module, the user 110 may set a variety of closing cost defaults 120, including but not limited to, lender fee, appraisal fee, credit report fee, title closing fee, title lenders policy, other title fees, state tax stamp, situational costs, and other costs. These items may vary from transaction to transaction and different entities may charge different amounts for these items. Typically, however, entities work with a set of providers or in a certain state, where these fees may largely not vary over shorter periods of time. Additionally, the user may access prepaid defaults 125, such as insurance premium and HOA costs. Additionally, the user may access and set various mortgage insurance 130 aspects, including but not limited to, borrower paid, single financed, lender paid, FHA loans, VA loans, Borrower paid, and others. Additionally, the user may adjust pricing dynamics 140, such as the margin adjustment, a pricing timeout, the length of a lock term including a long lock term, ARM dynamics, any lender credit limit, margin control, and SPL Vendor.

Additionally, the user (system administrator) may interact with a PPE Rules module 145. Through this module, the user may adjust details concerning the type of mortgage 150, including convention fixed, convention arm, FHA, VA, and VA Jumbo. Other types of mortgages 155 may include Jumbo Fixed, Jumbo ARM, Agency Jumbo-Fixed, FHA Jumbo-Fixed, FHA Jumbo-ARM, and Price Jumbo-Fixed. The user may adjust various features of these mortgages, including availability and adjustments.

Additionally, the user may interact with CERF rules module 160. CERF rules 165 include the necessity and level of credit, employment, various ratios of income to loan, and possible funding sources for funding. Additionally, the user may interact with an investors module 170 that allows for the addition and management of investors in the mortgage services and mortgages. Details concerning the investors 175 may include the name of the investors, actions in relation to the investors, as well as rate sheet management, variance tracking, and incremental investments. The warehouse module 180 can provide for information 185 concerning possible lenders, including their limits, their credit limits, any haircuts (in terms of discounts), transaction fees, interest rates, and renewal dates for contracts/agreements. Finally, the user/administrator may manage the users 190 of the Brevity program and the companies and venders they may interact with 195.

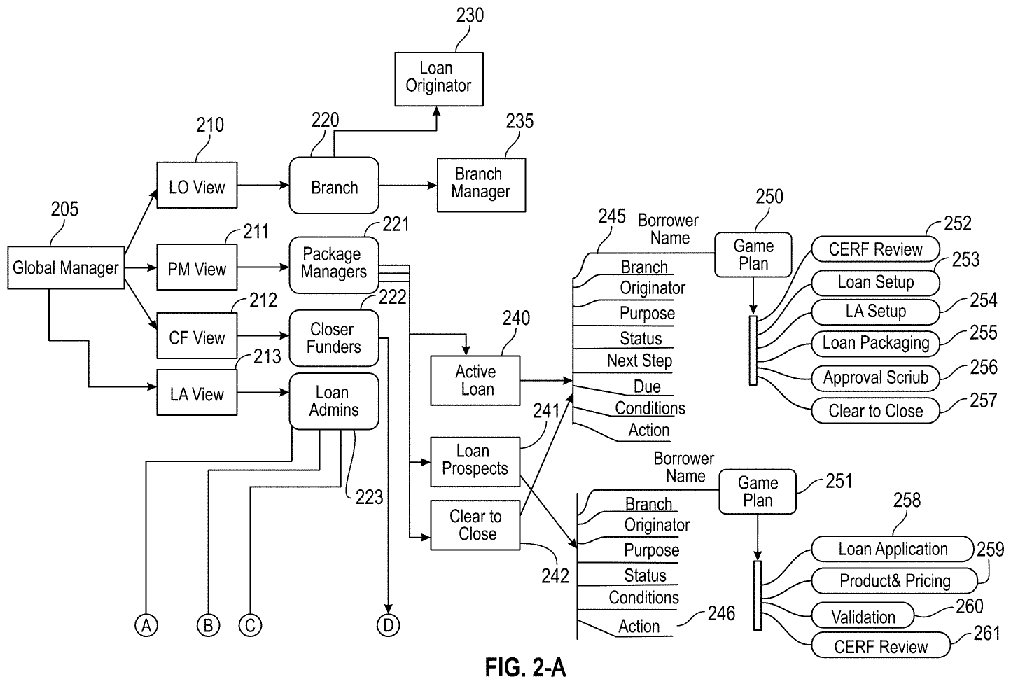

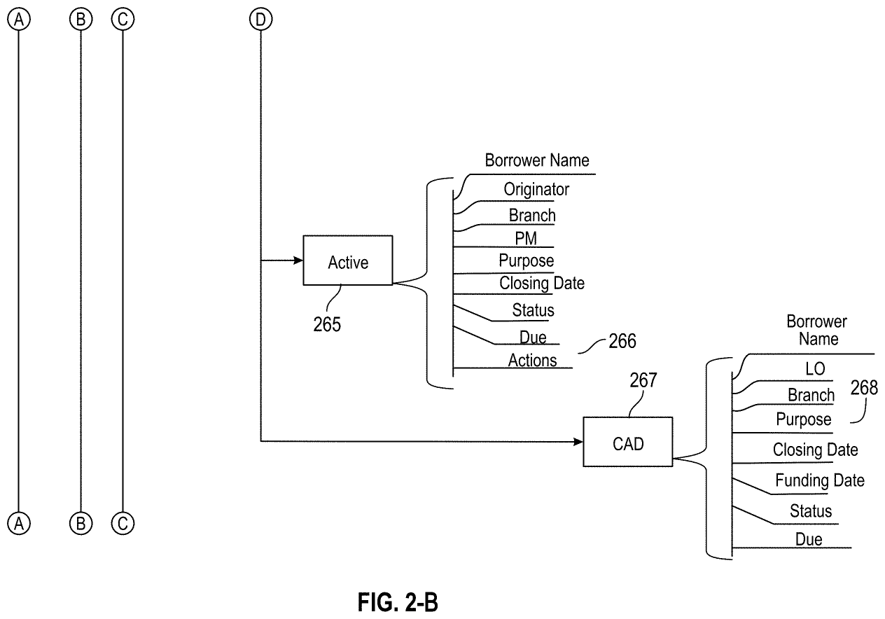

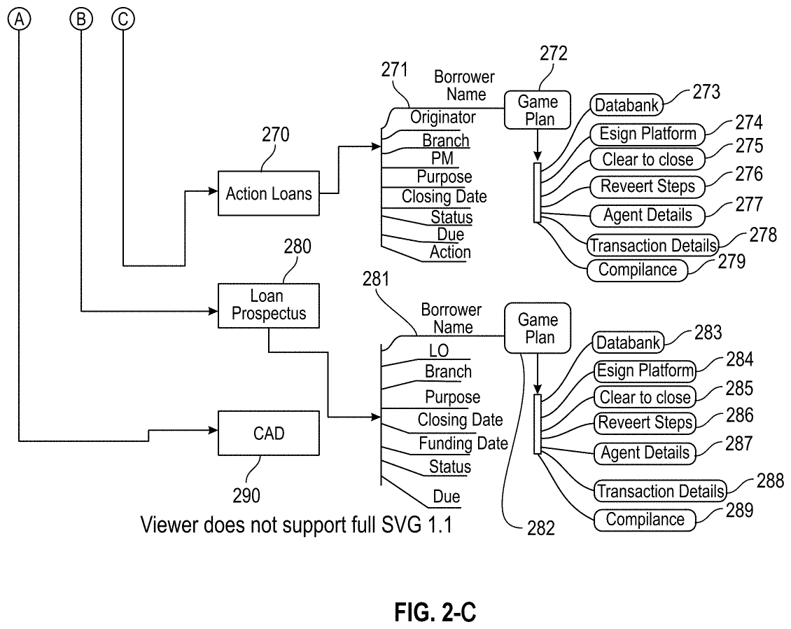

FIGS. 2-A through 2-C show a use-case diagram for global or branch managers. Typically, such a manager will have access to the various subsystem parts. This includes the various LO (loan officer views), the various packaging manager views (PM), the various closer/funder views, and the various loan administrator views. As shown, the branch manager can typically access and control various pieces of the process under the sub direction of the various officers, administrators, and managers. Global Manager 205 may interact with embodiments of the system via various views, including Loan Officer view 210, Packaging Manager view 211, Closer Funders view 212, and Loan Administrator view 213. From Loan Office view 210, the user may view activities as an individual Loan Originator 230 or a Branch Manger 235. From the Packaging Manger view 211, the user may view the packaging managers currently active 221 and their corresponding loans, including active loans 240, loan prospects 241, and clear to close loans 242 (loans ready to be closed). If the loans are active or ready to be cleared, the system will provide options and information 245 for managing the loans. The options and information 245 include the borrower name, the branch of origination, the originator, the purpose of the loan, the status of the loan, the next step to advance the closing of the loan, when the loan is due to be closed, if there are any conditions on the loan, and the last action taken. Each borrower is also reference to a Game Plan 250 for that borrower. The game plan incudes modules for CERF Review 252, loan setup 253, Loan Administrator Setup 254, Loan Packaging 255, Approval scrub 256, and clear to close 257.

Additionally, if the loan is still in the prospect stage, then options and information 246 provide the borrower name, the branch of origination, the originator, the purpose of the loan, the status of the loan, the next step to advance the closing of the loan, if there are any conditions on the loan, and the last action taken. As above, Game Plan 251 may be accessed, which provides submodules for loan application 258, product and pricing 259, validation 260, and ERF Review 261. From the Closer Funders module 212, an active 625 and CAD 640 module are available. From the active module 625 for active loans, the user may access options and information 266 that provides for the borrower name, the originator, the branch, the PM, the purpose, the closing date, the status, the due (what is next due for the loan) and the last action taken. Additionally, the user, through the CAD module 267 may access the borrower name, the loan office (LO), the branch, the purpose, the closing date, the funding date, the due (what is next due for the loan) and the last action taken.

Additionally, a user through the loan administrator module 223 may access modules active loans 270, loan prospects 280, and CAD 290. From active loans 270, the user may access options and information 271, which includes borrower name, originator, branch, PM, purpose, closing date, status, due (for items due), and action for the last action taken). The user may access the game plan 272, from which submodules databank 273, esign platform 274, clear to close 275, revert steps 276, agent details 277, transaction details 278, and compliance 279. Similarly, from loan prospects 280, the user may access options and information 281 concerning loan prospects, including borrower name, loan officer, branch, purpose, closing date, funding date, status, and due. The user may access game plan 282 from which submodules databank 283, esign platform 284, clear to close 285, revert steps 286, agent details 287, transaction details 288, and compliance 289.

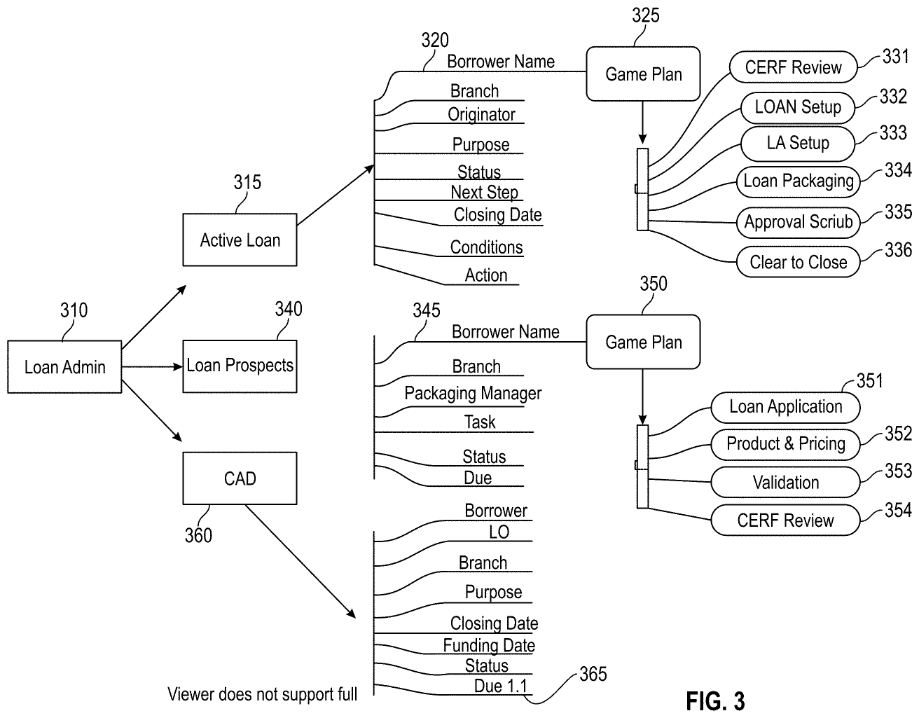

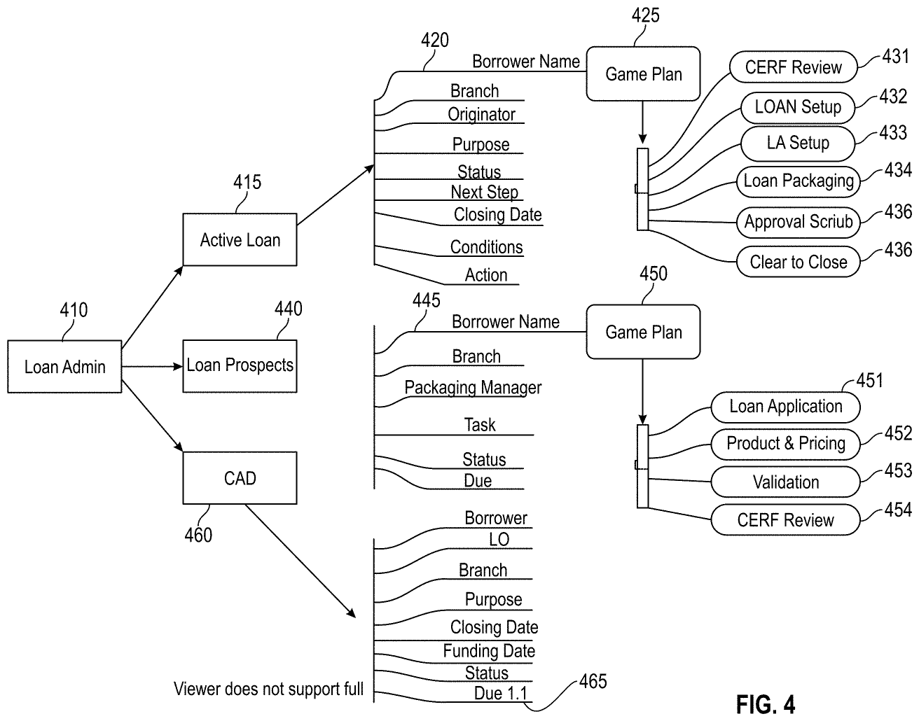

In FIG. 3, a use-case for the Loan Officer is shown. FIG. 4 shows the largely similar use-case for the Loan Administrator 310, 410. By way of example, the loan process may be viewed from the perspective of the loan officer, whom is one of the primary users of embodiments of Brevity. Shown here are critical parts of the Brevity system. Through interaction with Active Loan 315, 315 interfaces and Loan prospect interfaces 340, 440, the Loan Administrator/Officer may access and interact with a Game Plan, 325, 425, shared on the basis of the Borrower Name, among other information/options 320, 420, between the Loan Administrator/Officer interfaces and the Packaging Manager and Closer/Funder interfaces. These game plans are also accessible by the global or branch manager. From the game plan, the Loan Administrator/Officer may access CERF Review 331, 431, Loan Setup 332, 432, LA Setup 333, 433, Loan Packaging 334, 434, Approval Scrub 335, 435, and clear to close 336, 436. Under the Game Plan, calendaring and process flow is controlled, the needed data collected, processed, and validated, and shared within the borrow record, such that the Loan Administrator/Officer, the Packaging Manager, and the Closer/Funder can all operate in concert. Further the user may interact the loan prospects module 340, 440 in order to modify and develop loan prospects. Information/options 345,445 concerning loan prospects may include the borrower name, the branch, the packaging manager, the task, the status, and what is due. From game plan 350, the user may access loan applications 351, 451, products and pricing 352, 452, validation 353, 453, and CERF Review 354, 454. From the CAD module 360, the user may access information/options 365, including the borrower, the loan officer, the branch, the purpose, the closing date, the funding date, the status, and what is due.

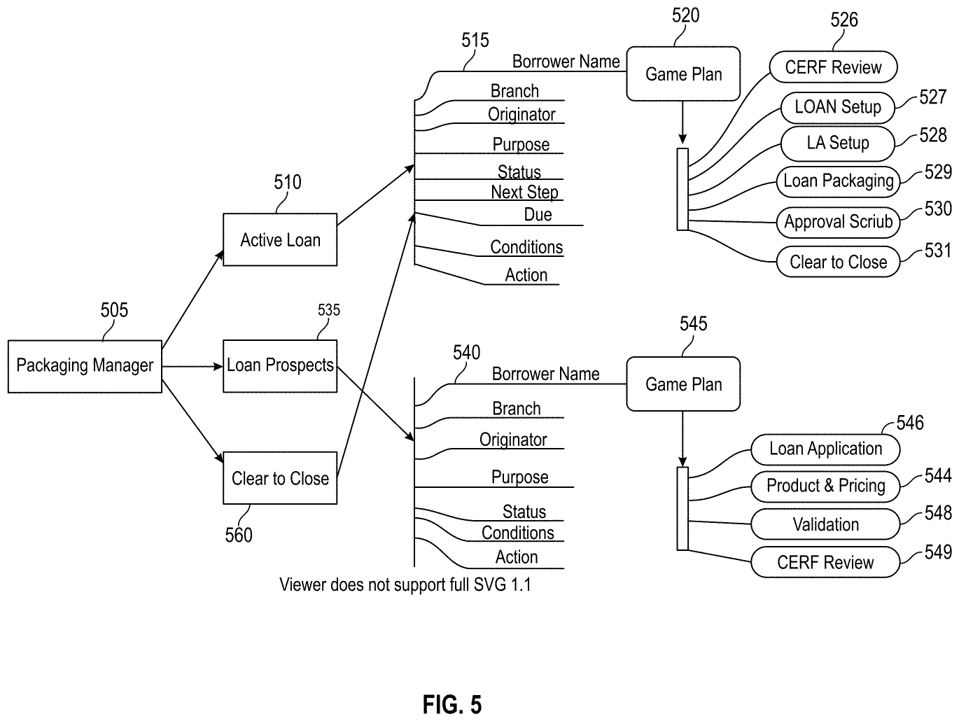

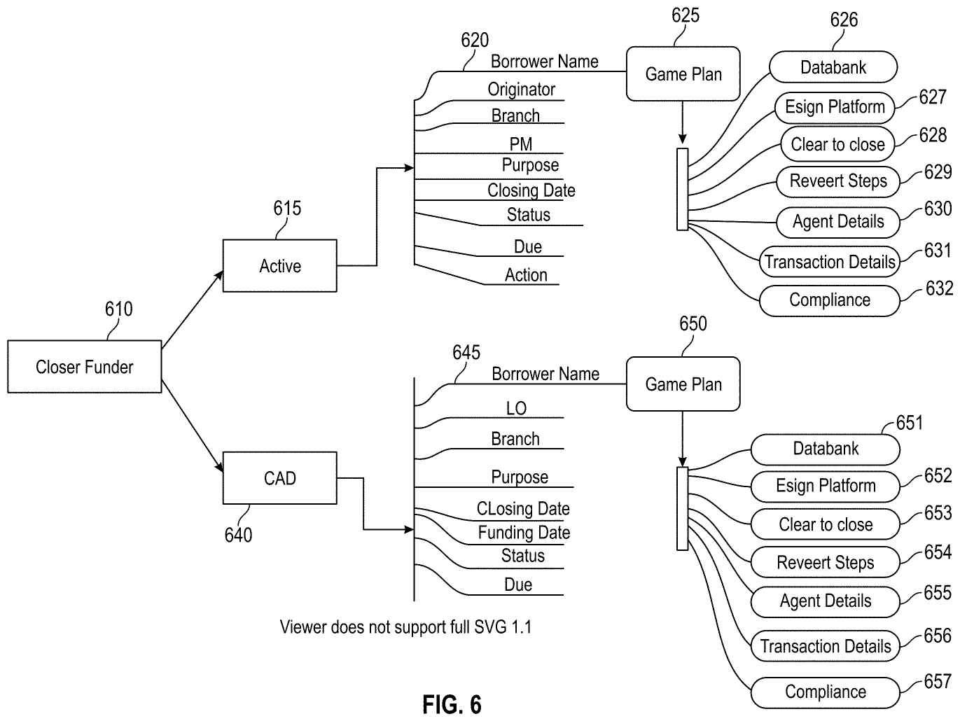

FIG. 5 shows a use-case for the Packaging Manager and FIG. 6 shows a use-case for the Closer/Funder, providing for the sharing and flow of actions for a user between the various users. In FIG. 5 the packaging manager 505 view is show. Here the user may chose to select and work with an active loan 510, loan prospects 535, or clear to close 560 (closing out a loan). The user may access information/options 515, which include borrower name, the branch of origination, the originator, the purpose of the loan, the status of the loan, the next step to advance the closing of the loan, when the loan is due to be closed, if there are any conditions on the loan, and the last action taken. From there, the user may move onto game plan 510, where the user may access submodules for CERF revie 526, loan setup 527, LA Setup 528, Loan Packaging 529, Approval scrub 530, and clear to close 531. Additionally, the user may access information/options 545 for borrower name, the branch of origination, the originator, the purpose of the loan, the status of the loan, if there are any conditions on the loan, and the last action taken. The user may move onto game plan 545 from which the user may access loan applications 546, product and pricing 547, validation 548, and CERF review 549. In FIG. 6, a closer funder 610 may interact via the active module 615 (for active loans) or the CAD module 640. The user may interact with information/options 630, including borrower name, the branch of origination, the originator, the PM, the purpose of the loan, the closing date, the status of the loan, the due date, and the last action taken. The user may interact with game plan 625 and interact with submodules databank 626, esign platform 627 (esign of documents), clear to close 628, revert steps 629, agent details 630, transaction details 631, and compliance 632. The user may interact with information/options 645, including borrower name, loan officer, the branch of origination, the purpose of the loan, the closing date, the funding date, the status of the loan, and the due date. The user may interact with game plan 650 and interact with submodules databank 651, esign platform 652 (esign of documents), clear to close 653, revert steps 654, agent details 655, transaction details 656, and compliance 657.

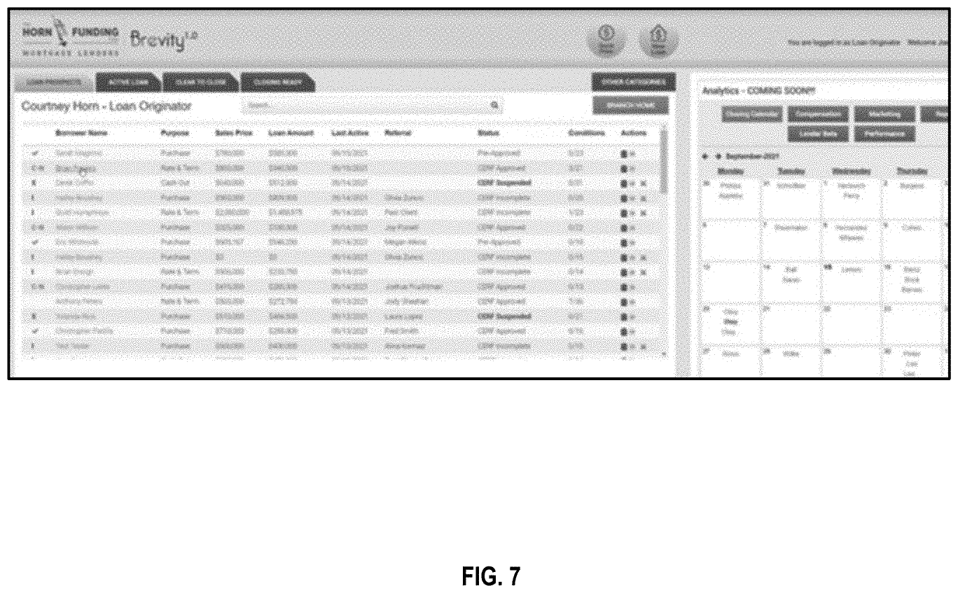

In many embodiments, Brevity functions from the point of view of the loan officer. The loan officer may approach Brevity from one of four different tabs: 1; Loan Prospects; 2. Active Loans; 3. Clear to Close; and 4. Closing Ready. This dashboard is shown in FIG. 7. For each load managed by the loan officer, the loan may have one of five statuses: 1. Loan initiated; 2. Pre-approved; 3. CERF incomplete; 4. CERF approved; 5. Loan submitted. These menus help the loan officer navigate the creation of loans.

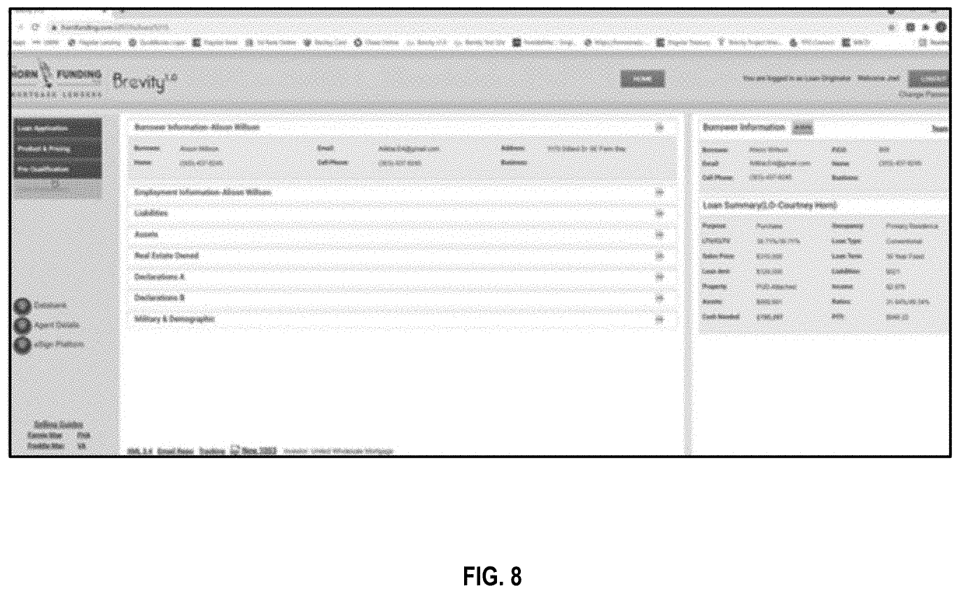

Next, the loan officer may fill the loan application, in a loan application window. The loan application is filled, and the Loans appears in Loan prospects, if there are no validations errors the Loan application can be completed. FIG. 8 shows one example of an interface for loan applications. Shown here are critical parts of the Brevity system. Through interaction with Active Loan interfaces and Loan prospect interfaces, the Loan Administrator/Officer may access and interact with a Game Plan, shared on the basis of the Borrower Name between the Loan Administrator/Officer interfaces and the Packaging Manager and Closer/Funder interfaces. These game plans are also accessible by the global or branch manager. Under the Game Plan, calendaring and process flow is controlled, the needed data collected, processed, and validated, and shared within the borrow record, such that the Loan Administrator/Officer, the Packaging Manager, and the Closer/Funder can all operate in concert.

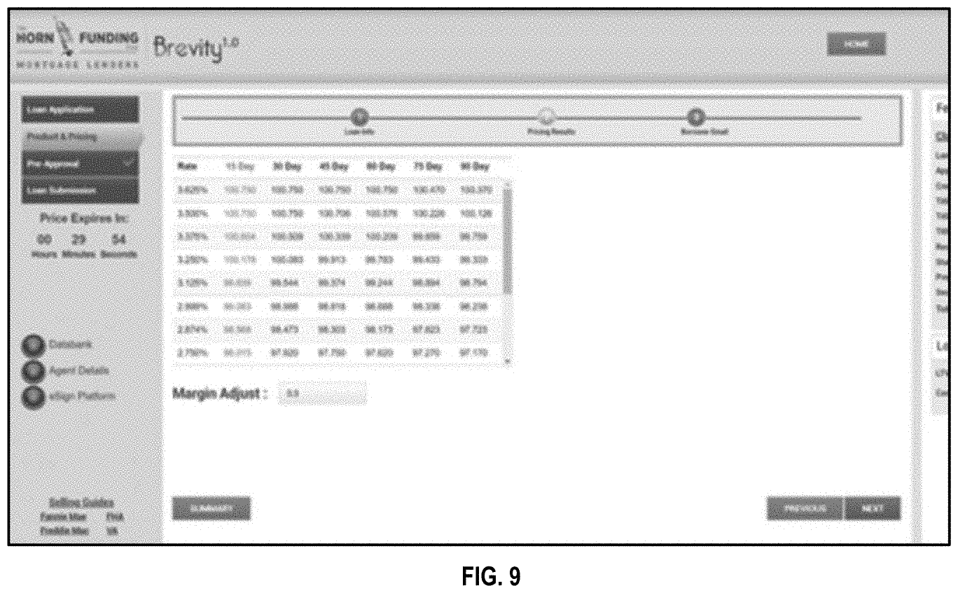

In FIG. 9, various rate pricing is shown. Here the Loan officer selects the Loan Type they are going, duration and interest rates—based on that the product is assigned and the pricing is defined.

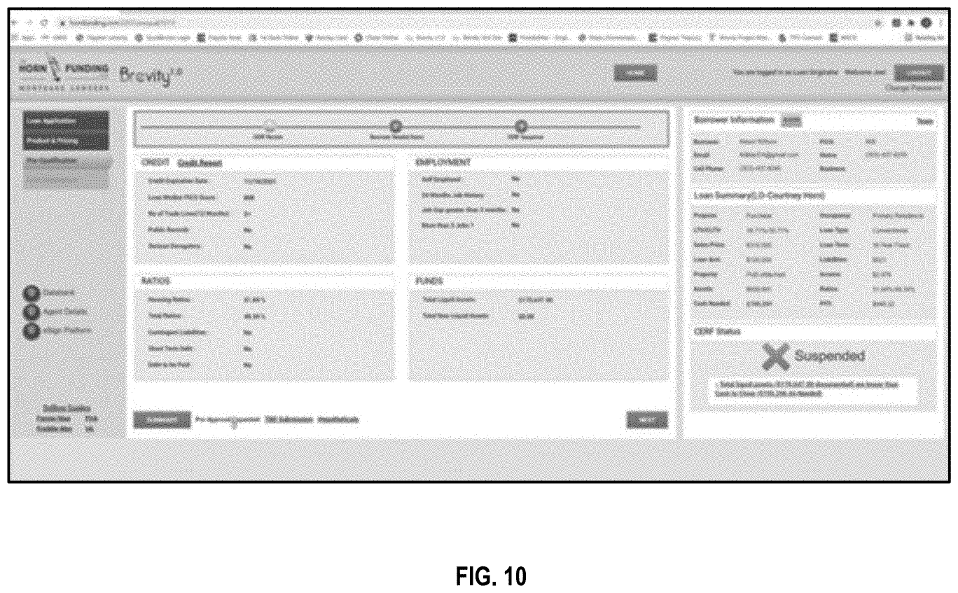

FIG. 10 shows one embodiment of the preapproval stage interface. In this interface, the Loan officer requests for the preapproval on Loan based on the credit score, Employment, Ratios and Assets—if the user gets Preapproval the Loan officer proceeds for Loan submission. Finally, the loan officer may proceed to loan submission. This is the were once all the documentation are provided by borrower and the Borrower agrees with the price and loan period (Lock period on loan). The LO completes the process to submit the loan for closing.

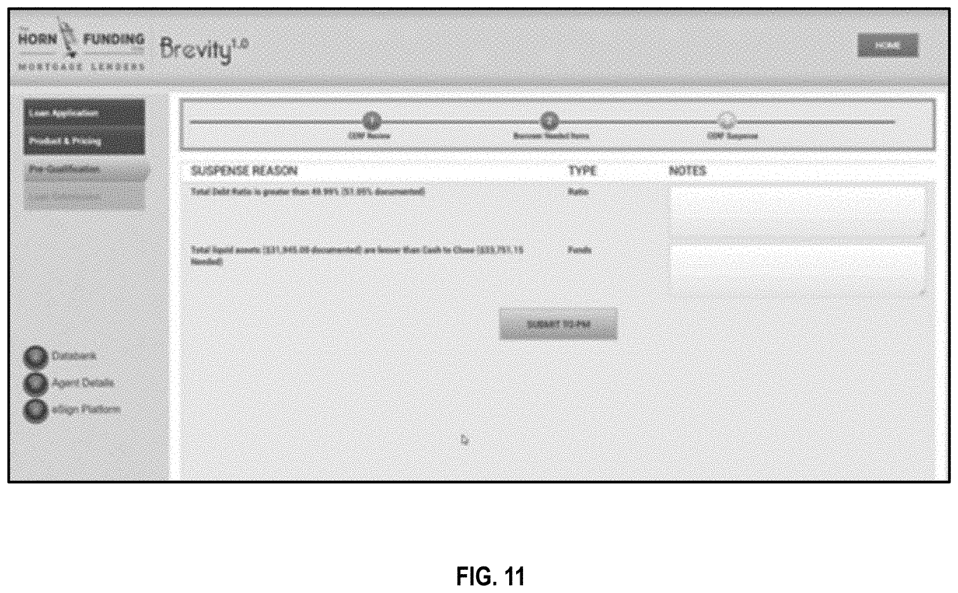

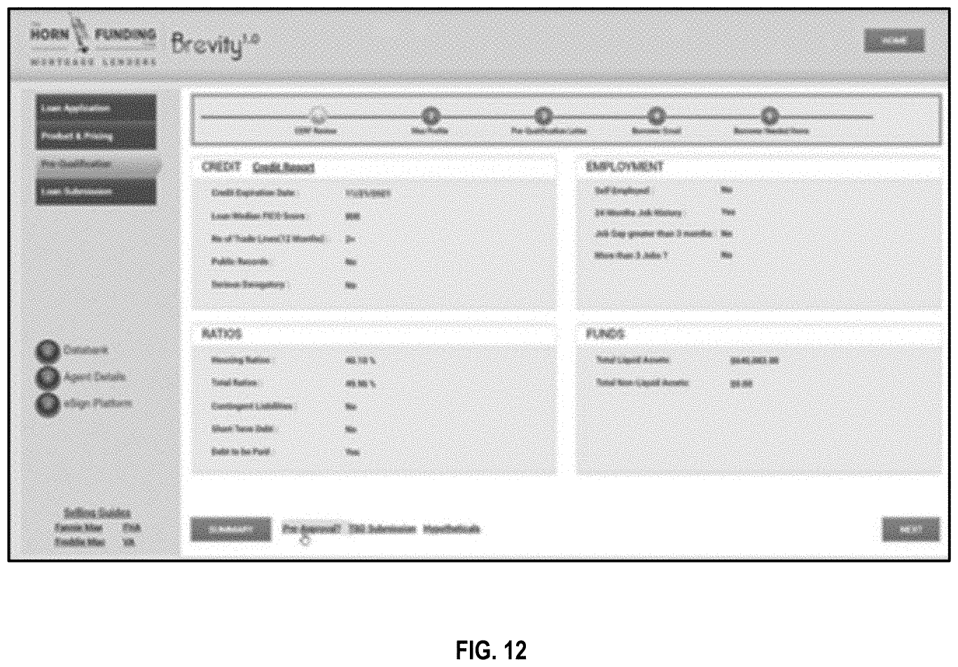

A part of the loan process is the packaging of loans in order to mitigate risk and turn them into tradable securities. This causes a back and forth between the loan officer and the packaging manager. There are four back and forth process in Loan prospects, CERF Suspense, pre-approval request, TBD submission, and Validation/Pre-qualifications on refinance loans. FIG. 11 shows one embodiment of an interface for CERF suspense. Whenever there is a CERF suspense the Loan Officer requests the packaging manager to review and approve. The pre-approval is granted in the shown document. In FIG. 12 an interface for pre-approval request is shown. If the loan meets all the CERF rules the Loan officer requests Pre-approval on the loan from Packaging manager. In some configurations, a TBD submission is necessary. This not used often, to be determined submission where we put the loan at higher level and submit to the investor (Not used currently in system).

In some scenarios, the loan officer may be working on the validation/pre-qualification of refinancing loans. On refinance loans there is not a requirement of pre-qualification as the loan is already CERF approved. Here the loan officer can do packaging manager Validations where they are seeking packaging manger to respond with what are the validations required (ex: the appraisal is required or not etc.)

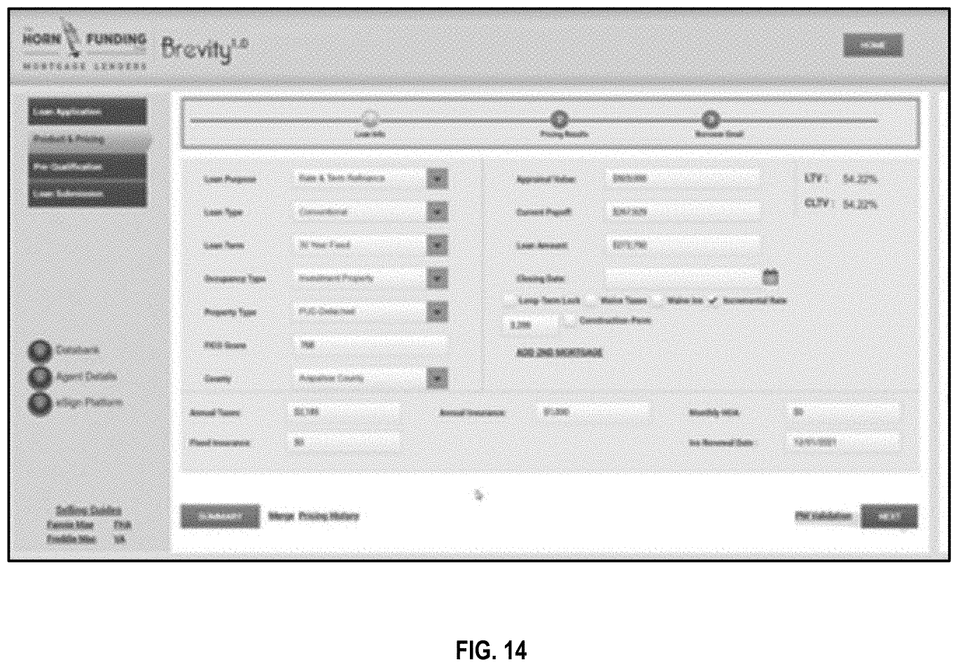

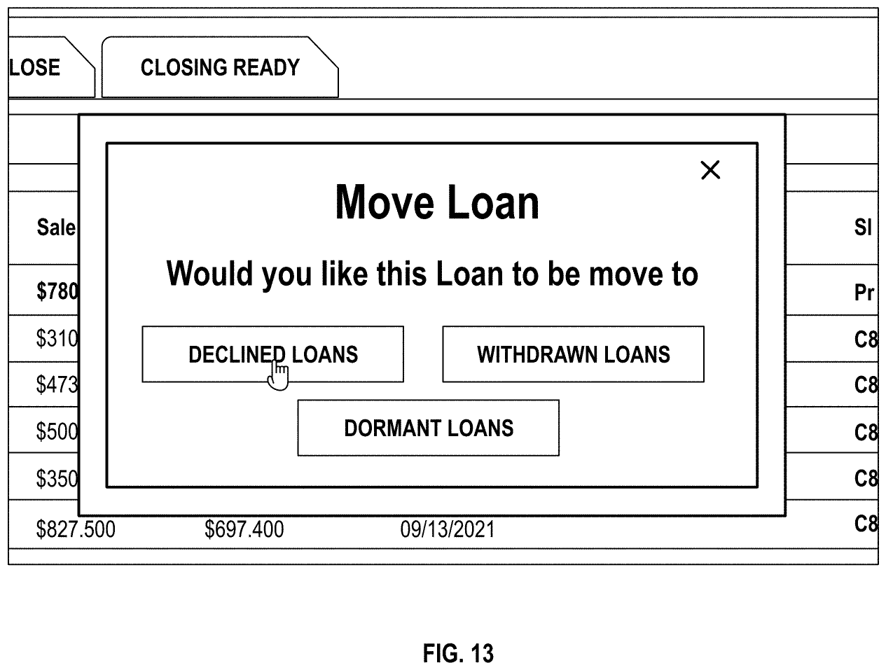

If the loan does not meet CERF qualification, then it will have to be moved to a different status. If the loan does not meet the CERF criteria it is not declined immediately, the loan is put in suspense mode so that Loan officer can get additional documentation and if the Loan officer is not able to move further the Loan is moved to Dormant Loans. FIGS. 13 and 14 show the interfaces for moving a loan to a dormant state.

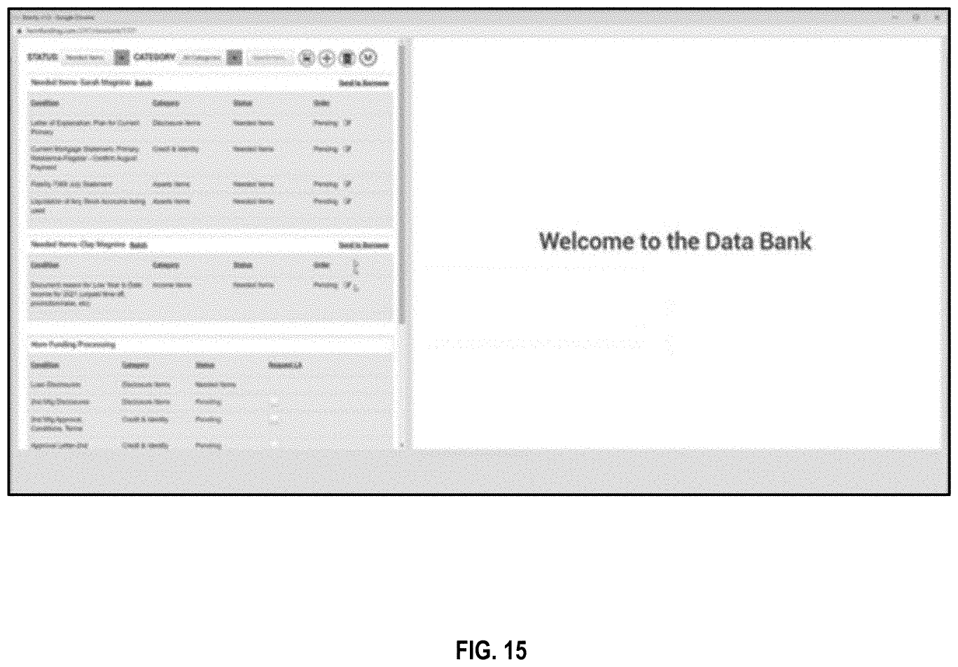

These interfaces used by the loan officer are useful to the preparation and clustering/packaging of loans. Additionally, the data bank is a separate popup user interface that may provide for enhanced processing via a rules engine that improves the processing efficiency of the system and the loans generated therein. FIG. 15 shows one embodiment of a databank interface. The data bank may be a separate popup, based on the rules engine which is run the conditions on the Loan are displayed and the data and conditions displayed are loan specific. In some embodiments, the user can manually add conditions in the databank and assign the condition to a respective person. In some scenarios, loans may require third party documentation. There are 3rd party items which are requested from 3rd party sites and uploaded here. This is shown highlighted in FIG. 16.

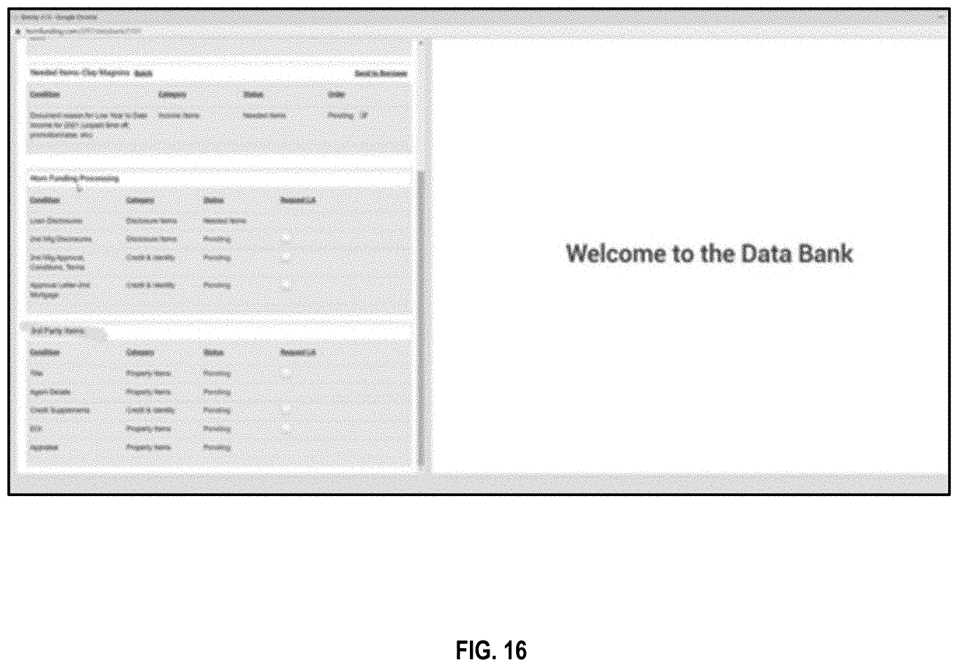

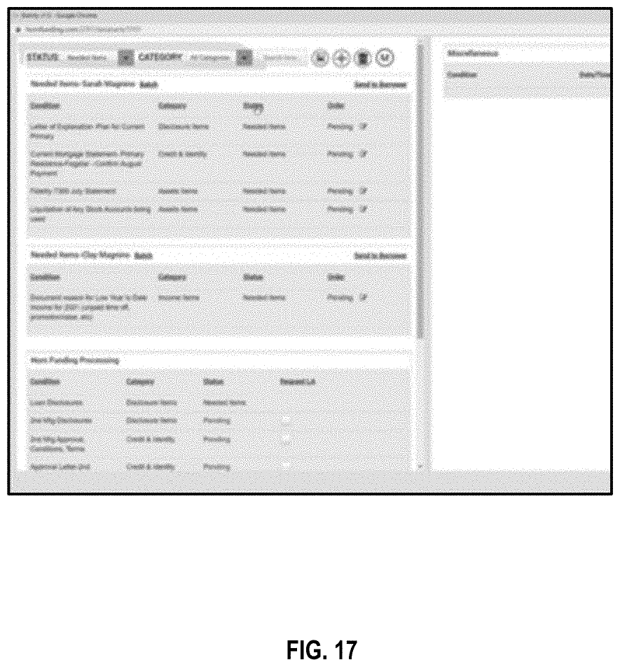

Additionally, as shown in FIG. 17, the user can filter in the databank using the category they belong or the stats of each condition. As shown in FIG. 18, there is an ability to modify the name of the condition and the Loan officer can communicate with LA using the functionality Request LA. This creates a task for LA to complete.

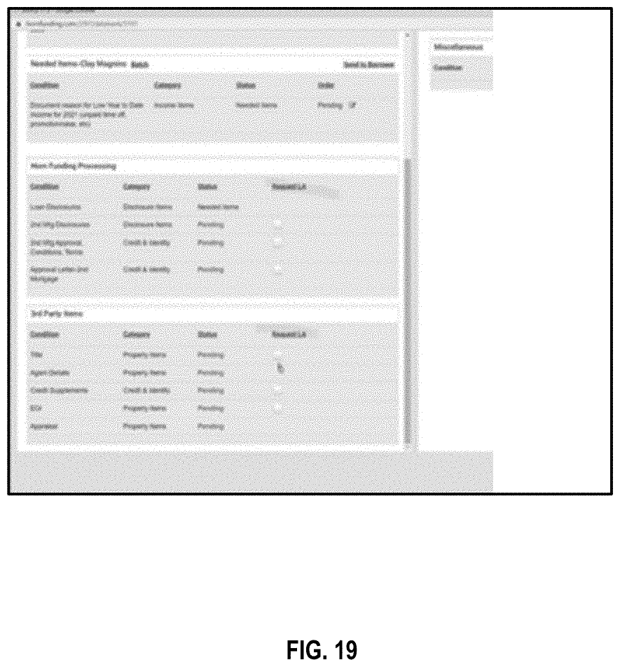

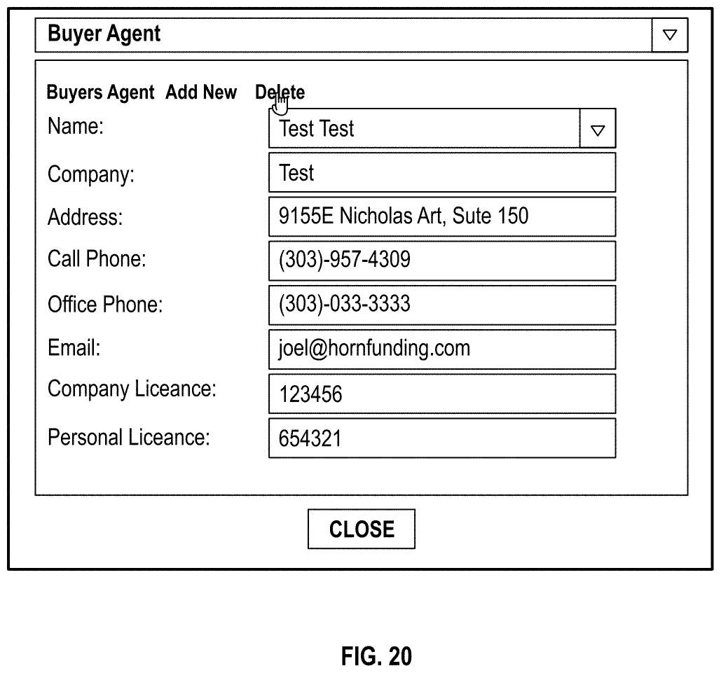

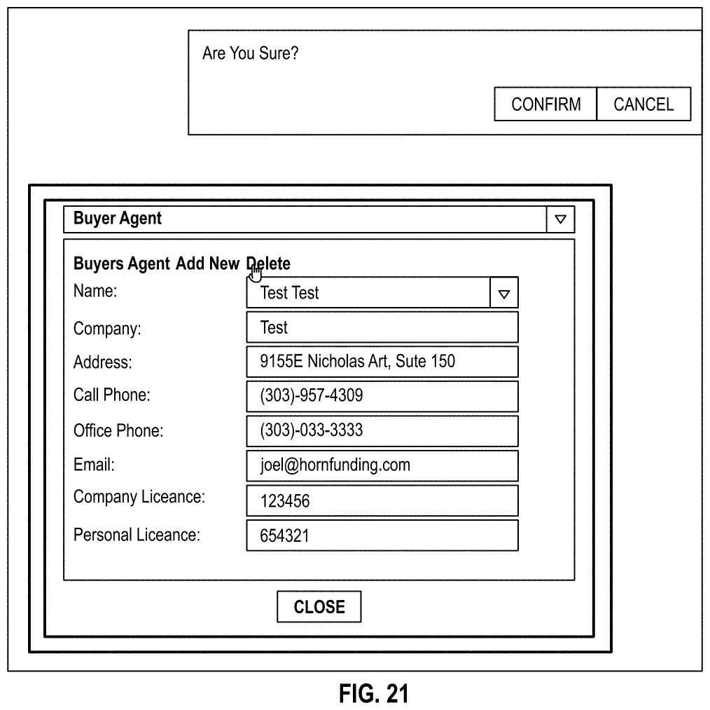

Additionally, an agent detail interface may be provided. FIG. 19 shows one embodiment of an agent detail interface. Agent Details is the functionality which hold the details of the all the 3rd party agents worked on the processing of the loan. FIG. 20 shows how when adding agent user can select existing agent or add new agent. FIG. 21 shows how whenever a new agent is added it is saved in a corresponding database and can be assigned to future loans. Users can delete the agent as well.

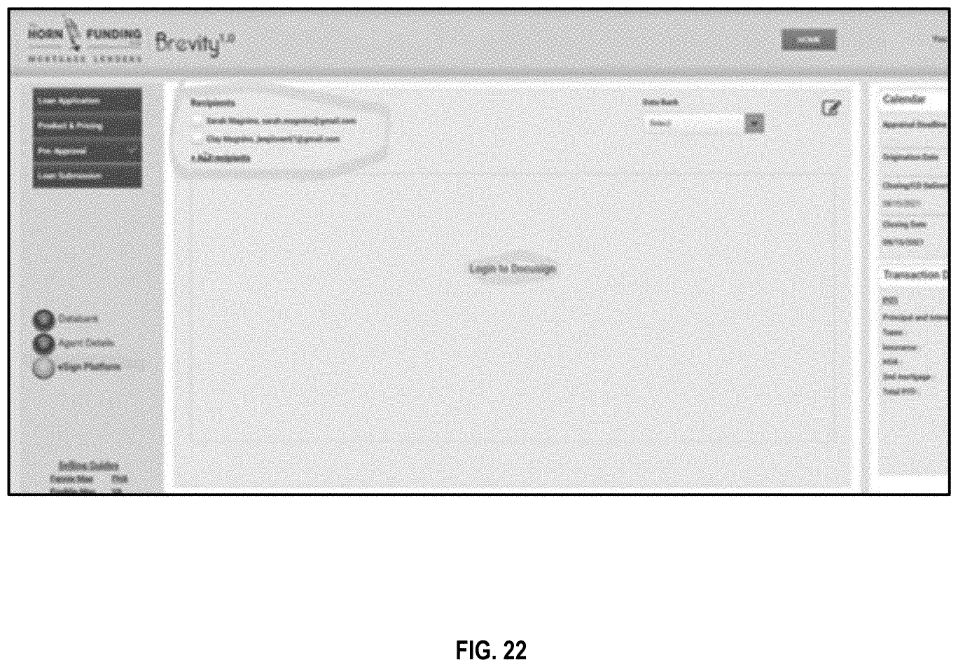

In some embodiments, Brevity may provide for a signature mechanism for the borrower. The borrower may be provided with an eSign platform in some configurations. FIG. 22 shows one embodiment of the eSign platform. The loan disclosures are sent via Docusign which is integrated with eSign and part of the Brevity. When user clicks on eSign it shows the borrowers as the recipients by default, but we can manually add recipients by clicking “Add recipients.”

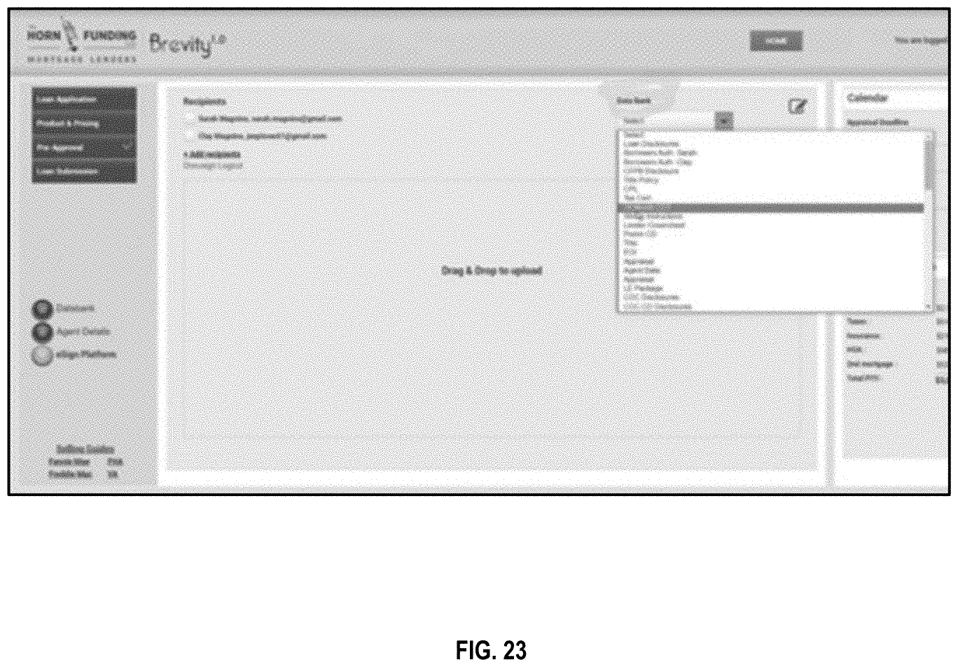

Once the user signs in Docusign, can drag drop or upload documents and assign to the conditions in the databank. The list showing as conditions in the Docusign are the same needed conditions in the data bank once that is done user can send email to the borrower. FIG. 23 shows an embodiment of the corresponding interface.

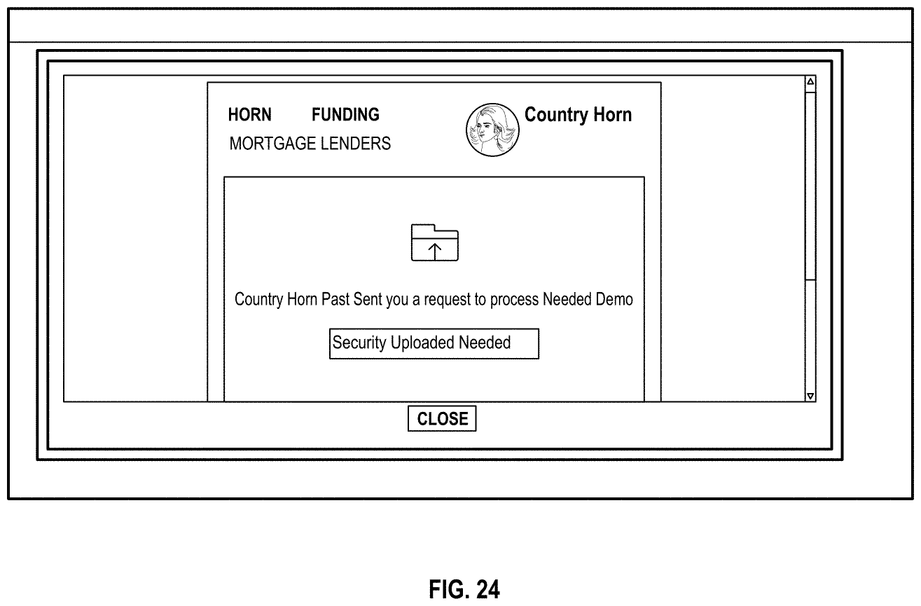

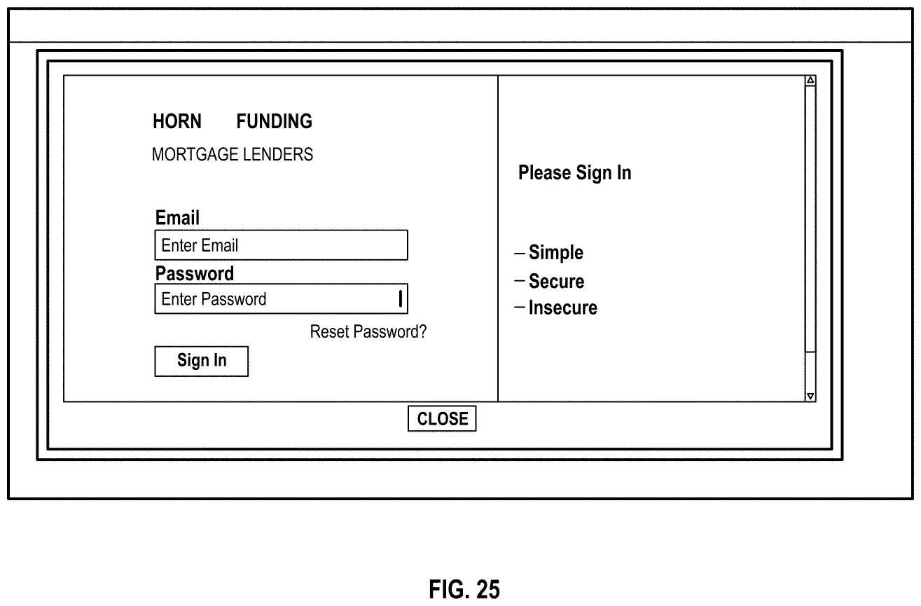

The borrower receives an email requesting the Esignature. FIG. 24 shows an example of an email for this request. The emails sent to Borrower would have content displayed in this form. Alternative methods of contact are possible as well, including but not limited to text message. Once the user clicks on the “Securely upload needed item” button user will be navigated to an upload page where they can attach the required documents which would be uploaded to Databank. FIG. 25 shows an example of such an interface.

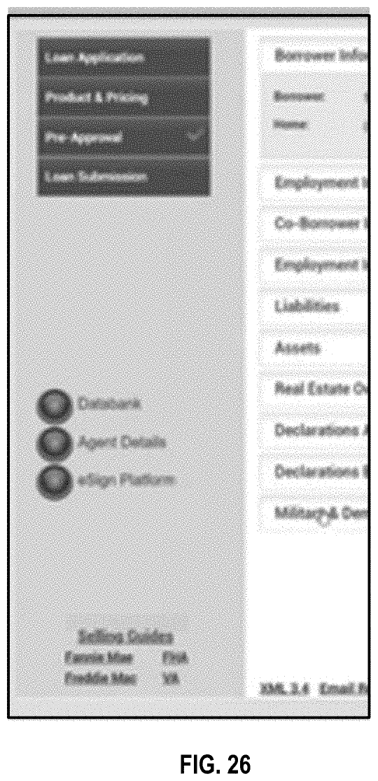

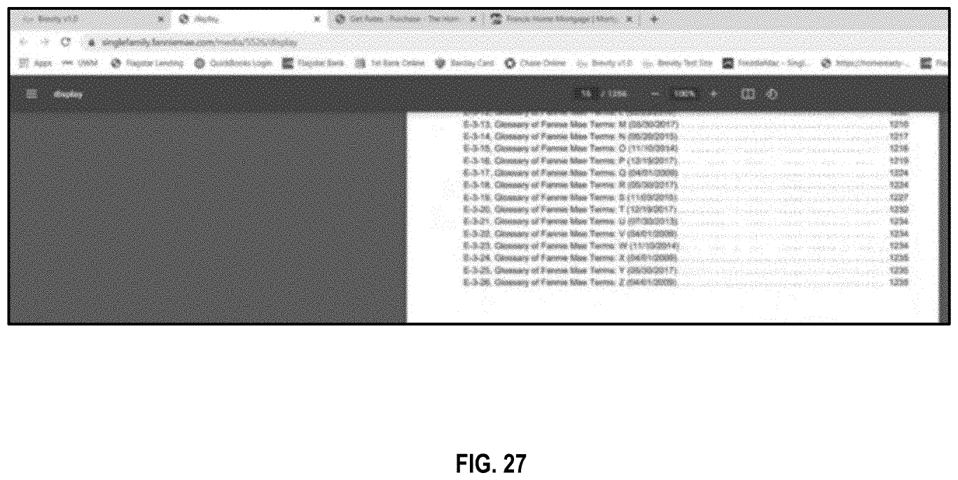

In some embodiments, Brevity may include selling guides. This has documents that shows the FHA, VA, Freddie, Fannie Mae's guidelines for a loan. FIGS. 26 and 27 shown an example of an interface for such guides.

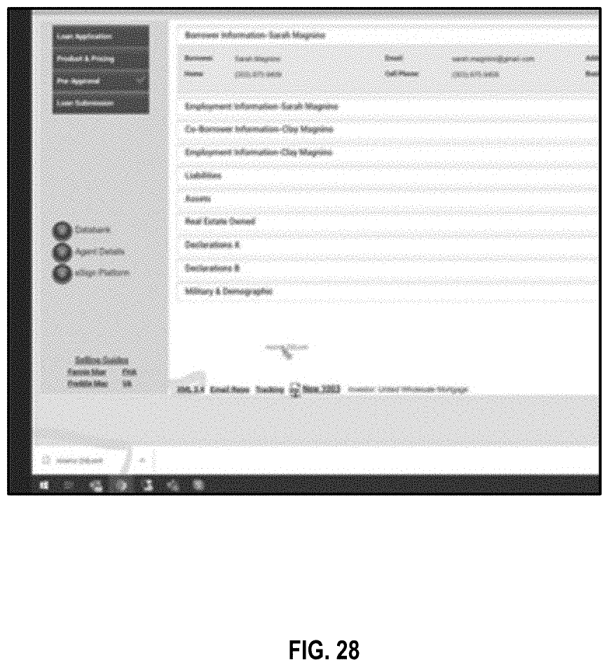

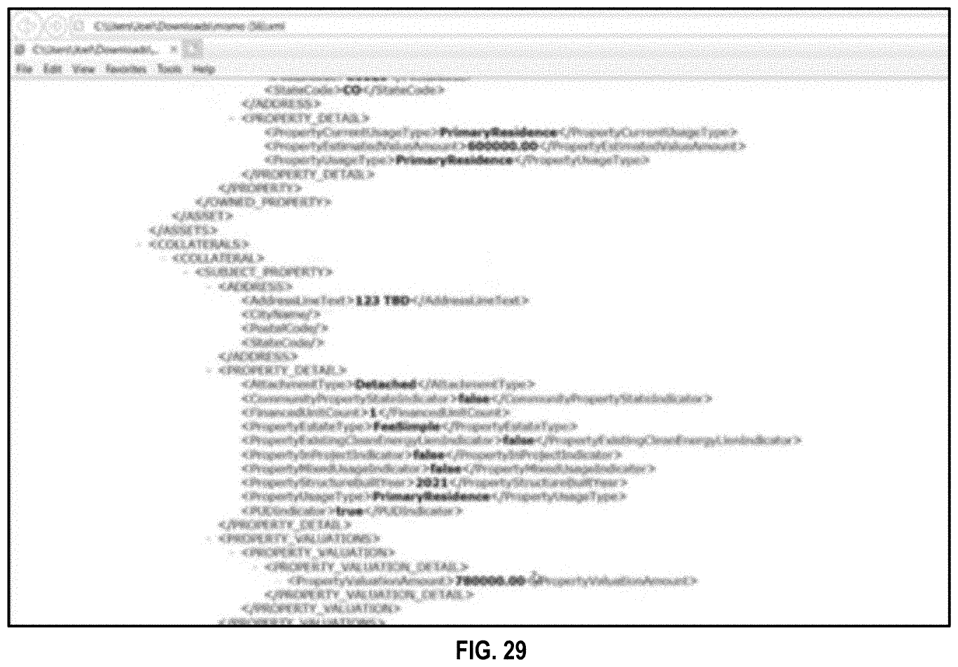

Embodiments of Brevity may include an export functionality. For example, the system may include and XML 3.4 export functionality. If the User wants to export the XML file of the loan details can click on the XML 3.4 and would be able to download the mismo file This is usually used to transfer the loan details into another system. FIG. 28 shows an example of such an interface and FIG. 29 shows an export.

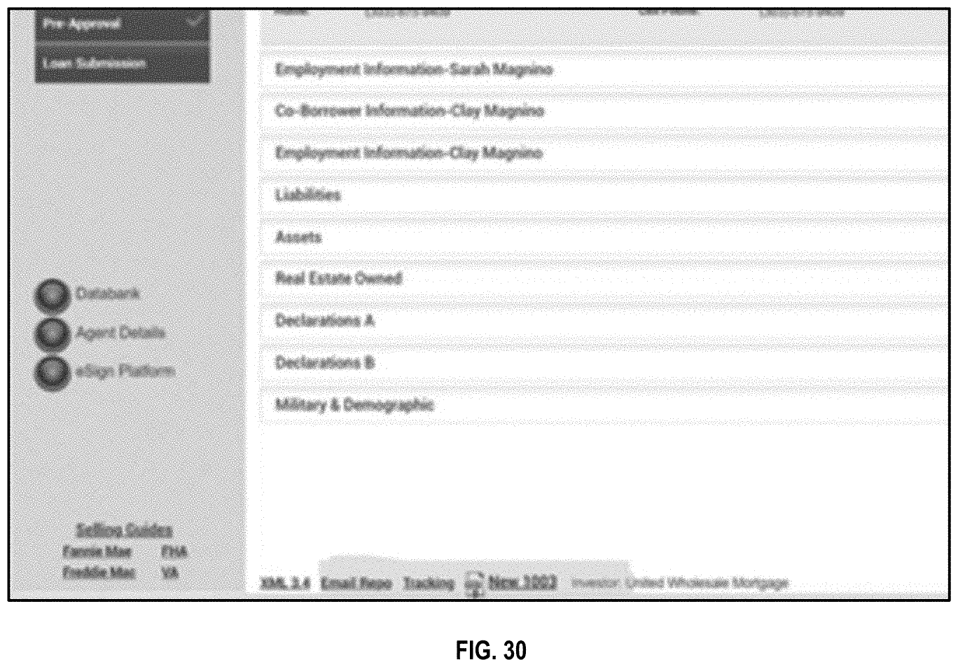

Embodiments of Brevity include an email repository interface. Email Reop is repository of all the emails sent out using Brevity for that loan. Usually this is used for loan officer to track what emails have been sent and any audit trails. FIG. 30 shows an example of a repository interface.

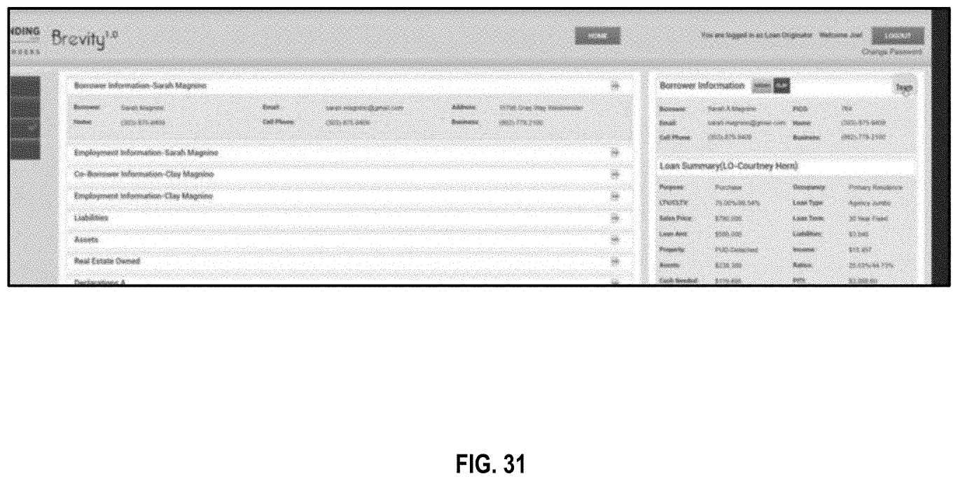

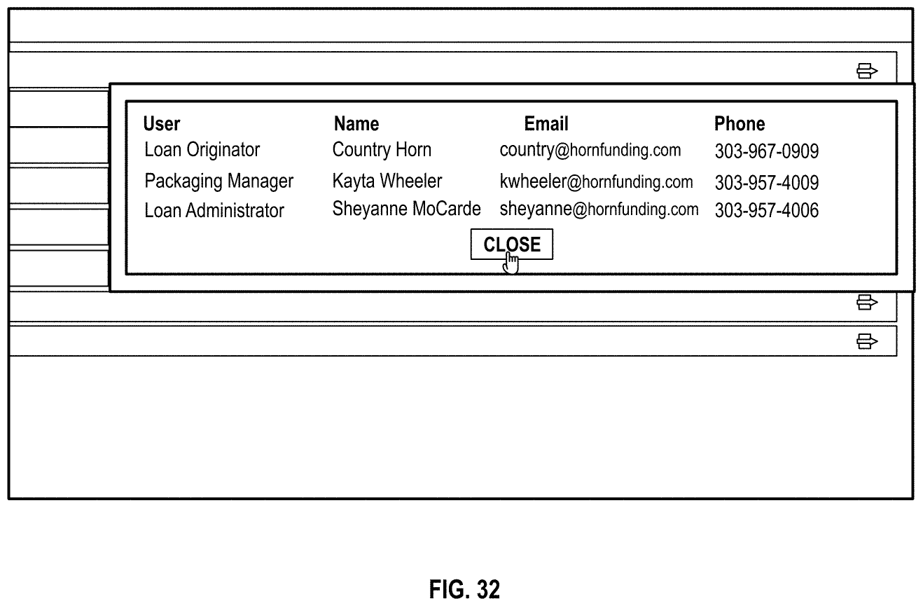

In some embodiments, a team interface screen is included that provides for the user an indication of various team members assigned to loan projects. FIGS. 31 and 32 show an example of such an interface.

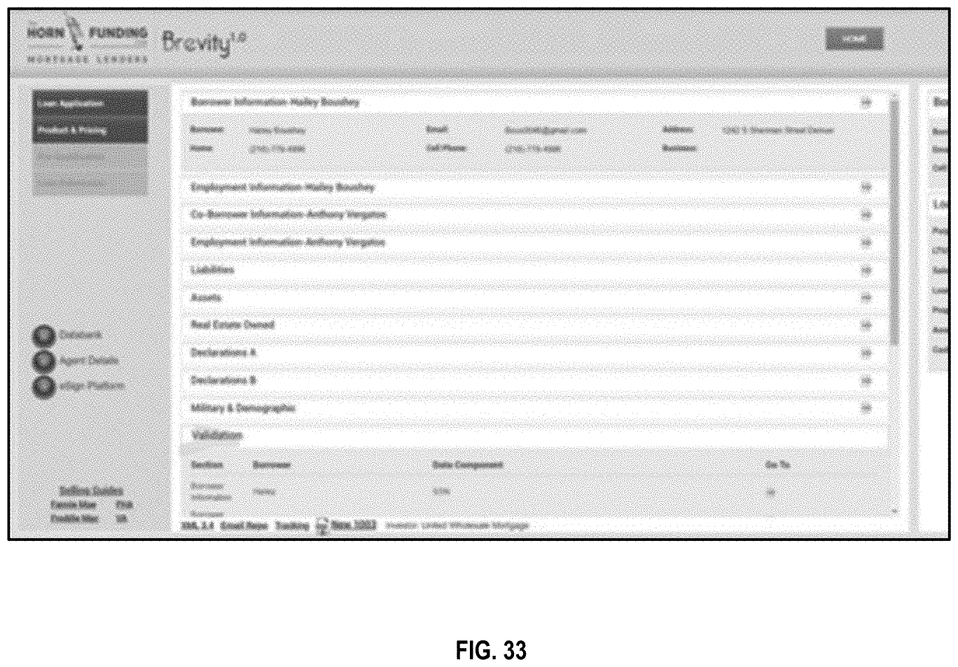

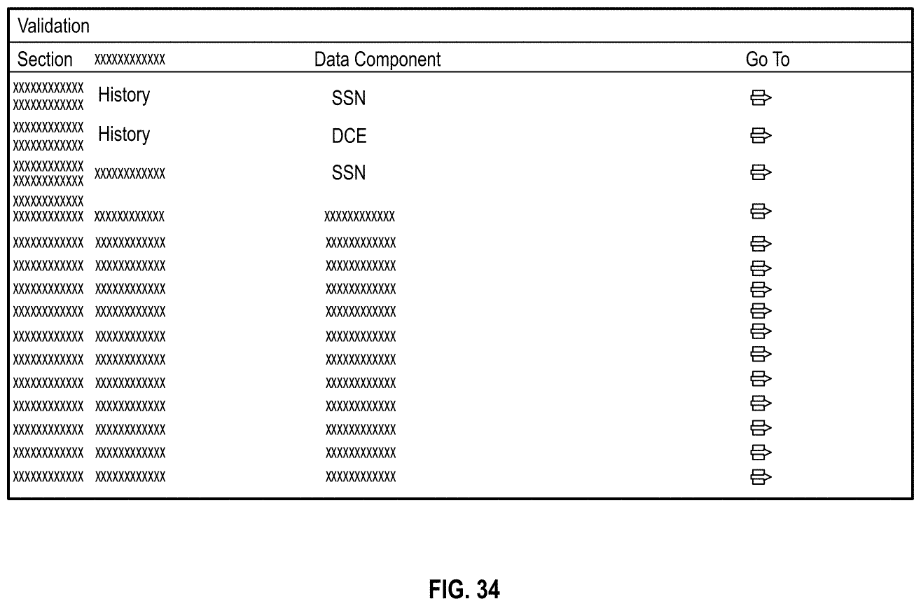

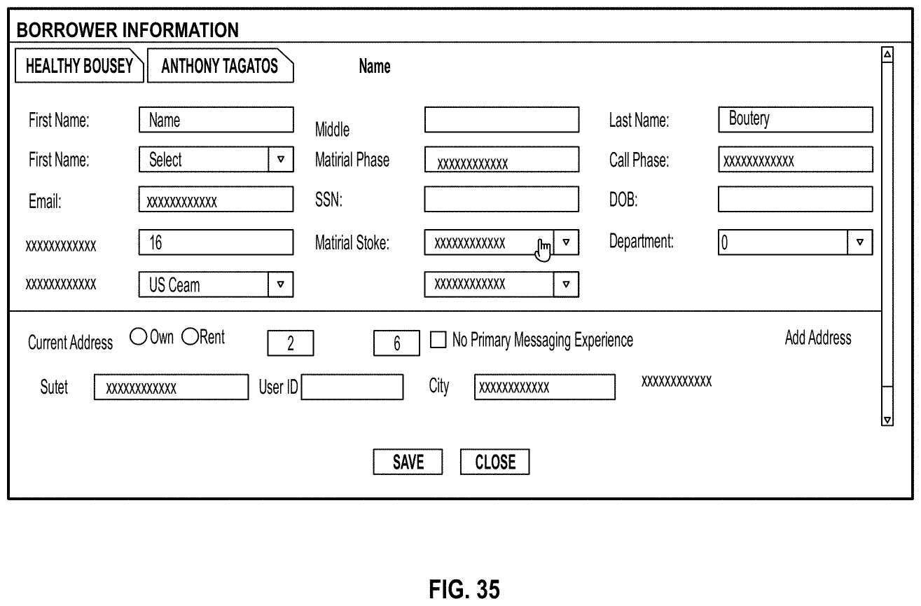

Additionally, embodiments of the Brevity interface may include a loan application-validation screen. FIG. 33 shows an interface for whether there are any open validations on the loan the Validations tab gets enabled in the Loan application screen. FIG. 34 shows that when a user clicks on validations the system navigates to the complete validations on the loan. When the user clicks on the goto link it takes to field which needs to be updated, for example when user click on go to link on date of birth the user is navigated to the DOB field in Borrower information (see FIG. 35).

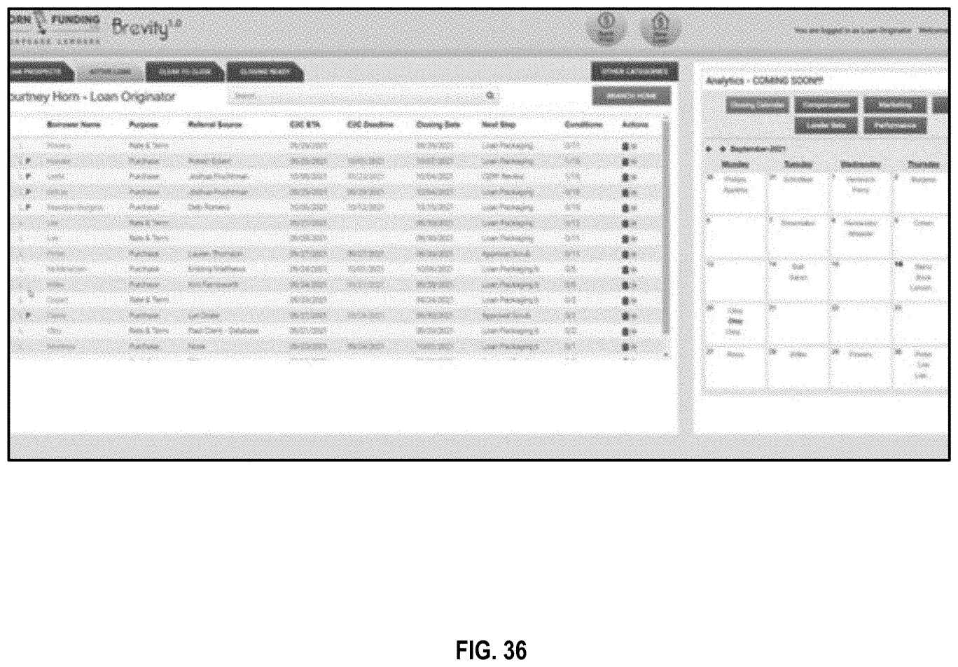

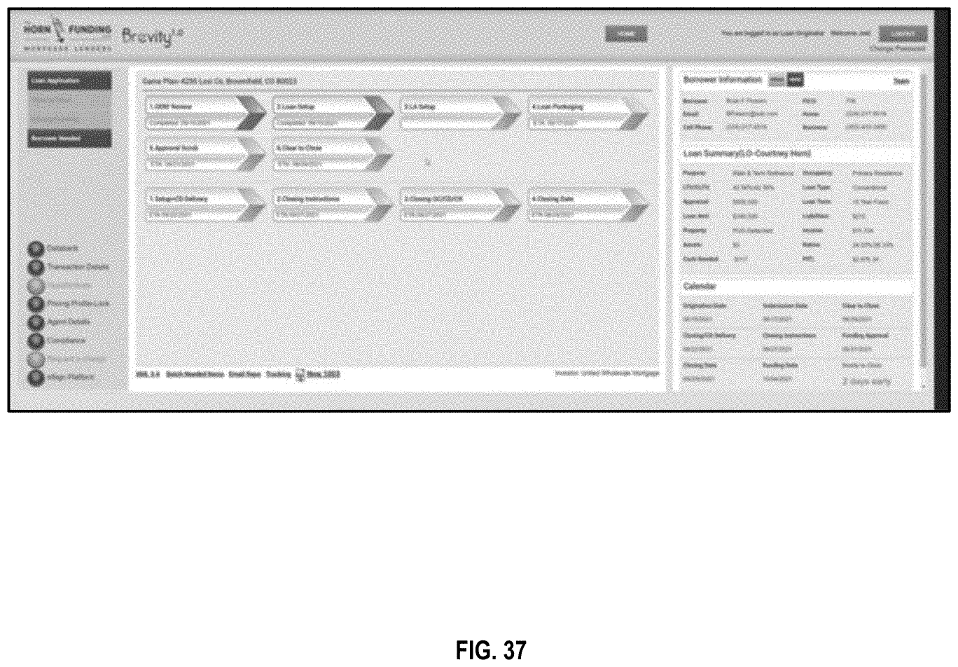

In some embodiments, the Brevity system may include an active loans tab as shown in FIG. 36. A loan officer may select and active loans tab. As shown in FIG. 37, when a Loan officer selects a loan which is Active Loans tab the Game Plan is show where the LO can ETA of each role. This selection may show what steps are completed and what steps are pending. Note that LA setup is not defined in all Loans: As this user role comes into picture only when the required documents are not submitted. LO cannot update the dates in this screen. Once the Loan is in active tab the LO cannot change any loan data it is “Read only.”

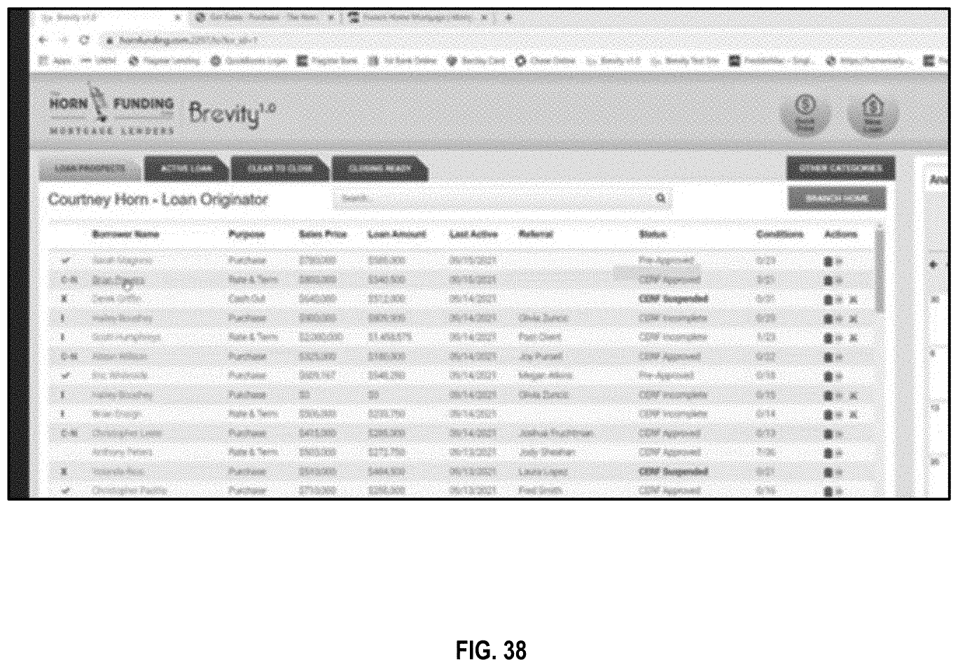

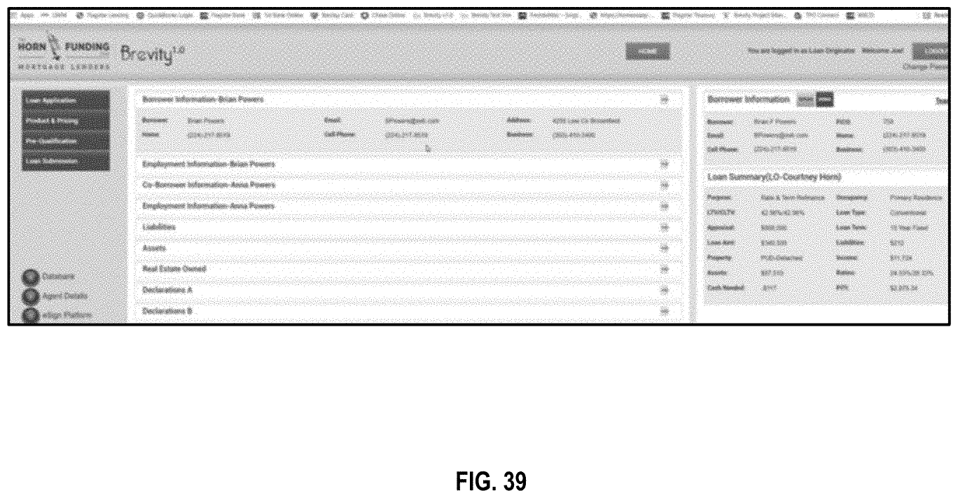

In some embodiments of Brevity, interfaces for loan officer flow for preapproved status loans are included. FIG. 38 shows an example of a refinance loan type interface. At this stage of the Loan, has gone through underwriting and packaging manager has approved the Loan. As shown in FIG. 39, which shows an example of an interface, the Loan officer goes over the documentation in the databank. The loan officer checks the complete application, sends the pricing details with borrower and once the borrower agrees the loan officer sends the conditions to the packaging manager and once the packaging manager approves the loan, the loan officer communicates to borrower and Borrower agrees to move forward with loan—the Loan moves to Active Loan.

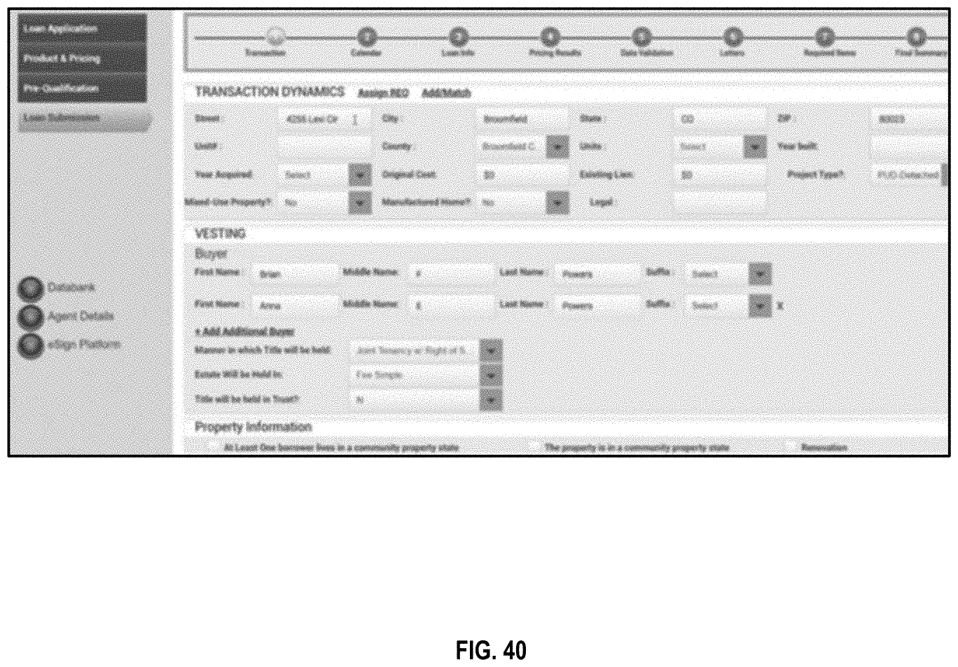

In some embodiments, a loan submission interface is included in the Brevity system. FIG. 40 shows an example of a loan submission interface. In the Transaction Screen, the loan officer verifies the property details (From External county site) type of property, time they purchased, and other details. The loan officer may check the Borrower data confirmation and if any required data is not filled, the system does not enable next button.

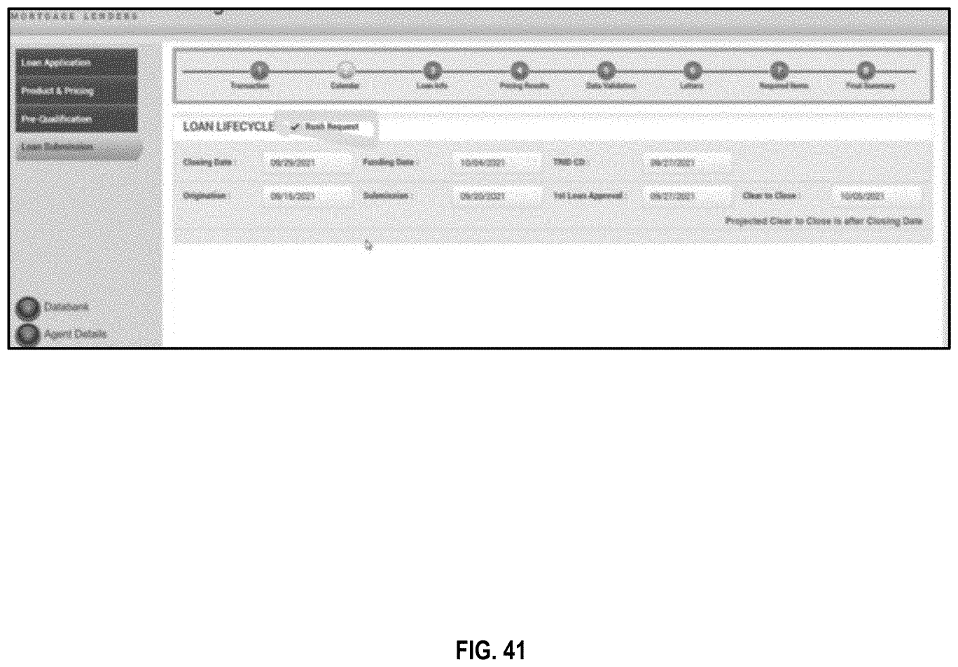

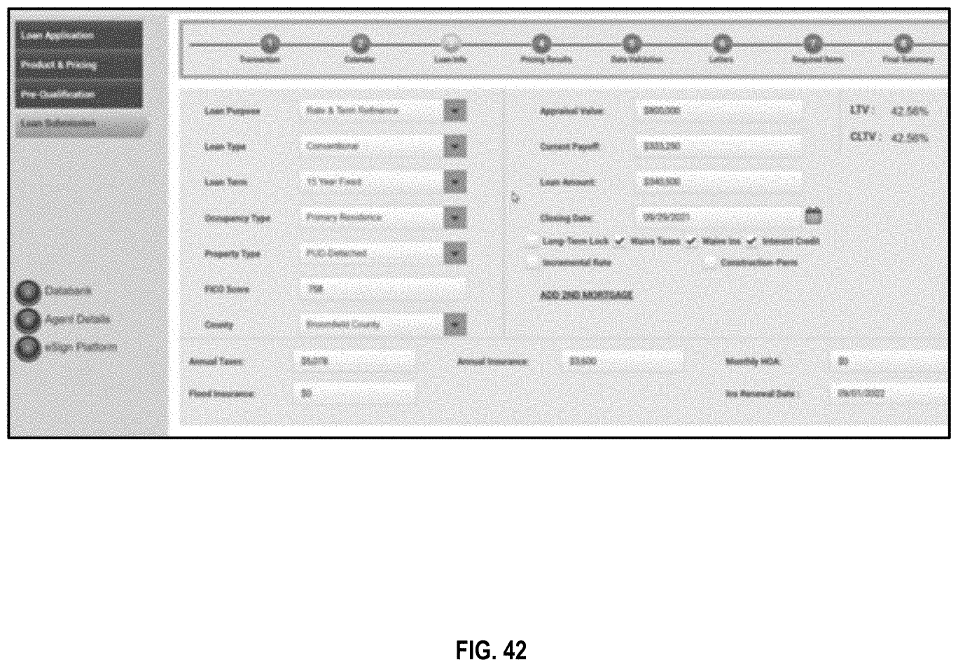

In some embodiments, a calendar screen is included in the Brevity system. FIG. 41 shows an example of a calendar screen. From the calendar screen, the loan officer can request to change the closing date by clicking the “Rush Request” check box. In many configurations, the Dates are predefined (based on origination date the rules trigger the other dates). Additionally, the Closing Date is usually 5 business days from the origination date (Hardcoded by system admin). In some embodiments, this may be modified. Additionally, the System Admin defines the date period but, in the screen, LO can request “Rush Request”->Packaging manager receives notification who internally can allow the date change when approved new date is displayed. Finally, the Packaging manager can change dates based on the compliance rules.

In some embodiments, a loan info screen is included in the Brevity system as shown in FIG. 42. Here, if there are any pricing change then a duplicate screen is created with new page so that the LO don't need to manually update all the changes. Additionally, if there are no changes, the loan officer may proceed to an additional screen.

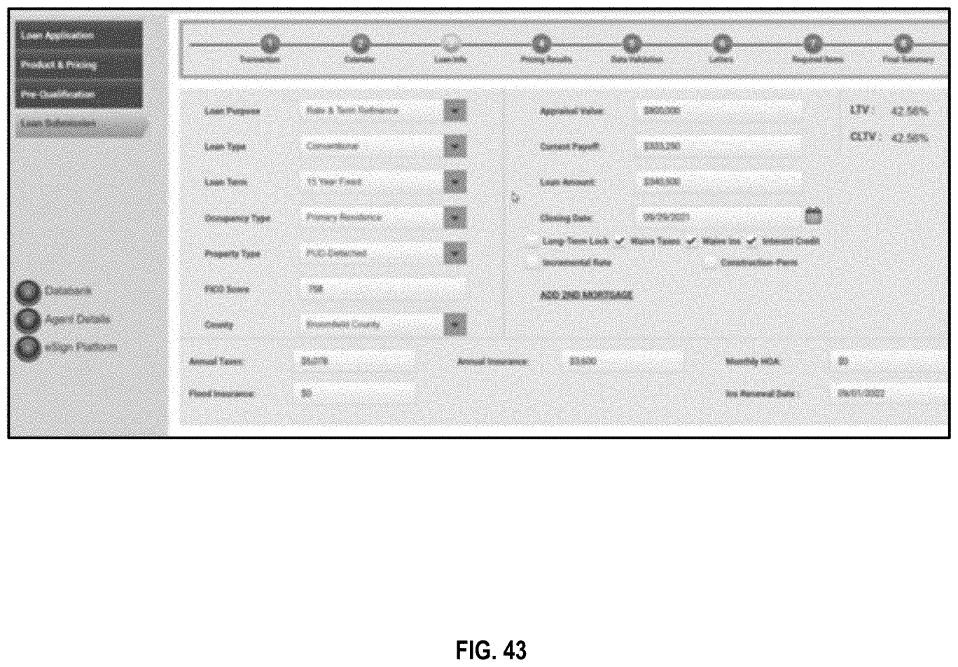

In some embodiments, the pricing screen shown in FIG. 43 is included in the Brevity system. In the pricing screen, the loan officer selects the pricing agreed with the borrower and selects to continue. Then the loan officer reconfirms the Taxes & insurances all are good and clicks on Next. Then the loan officer can see the Amortization schedule.

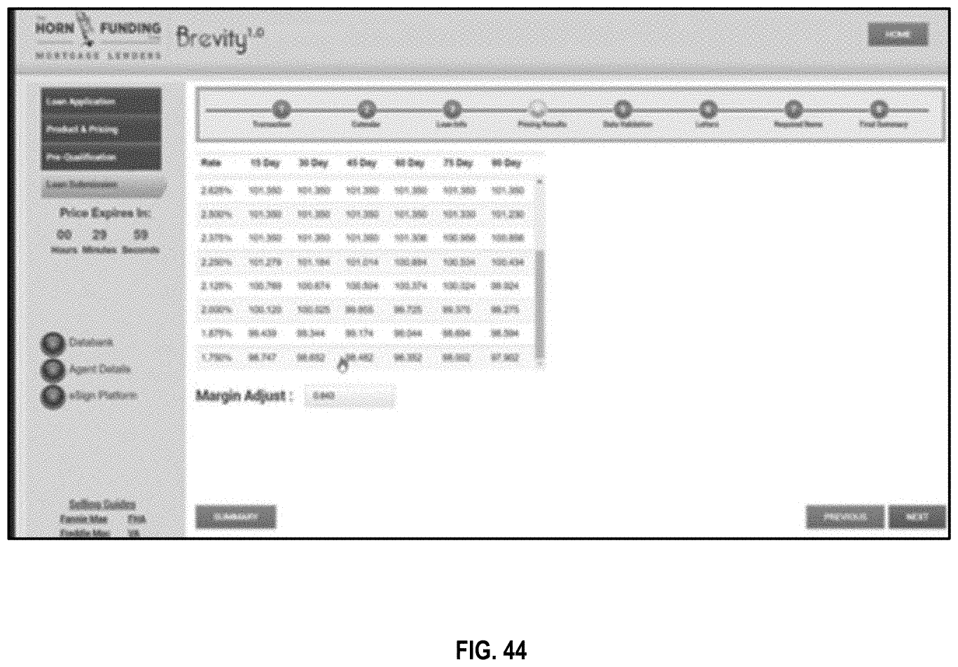

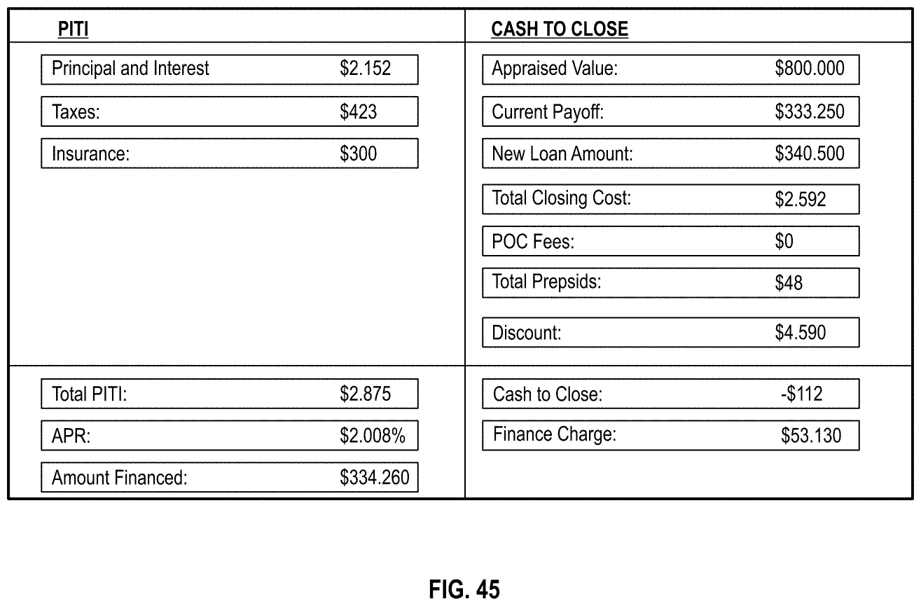

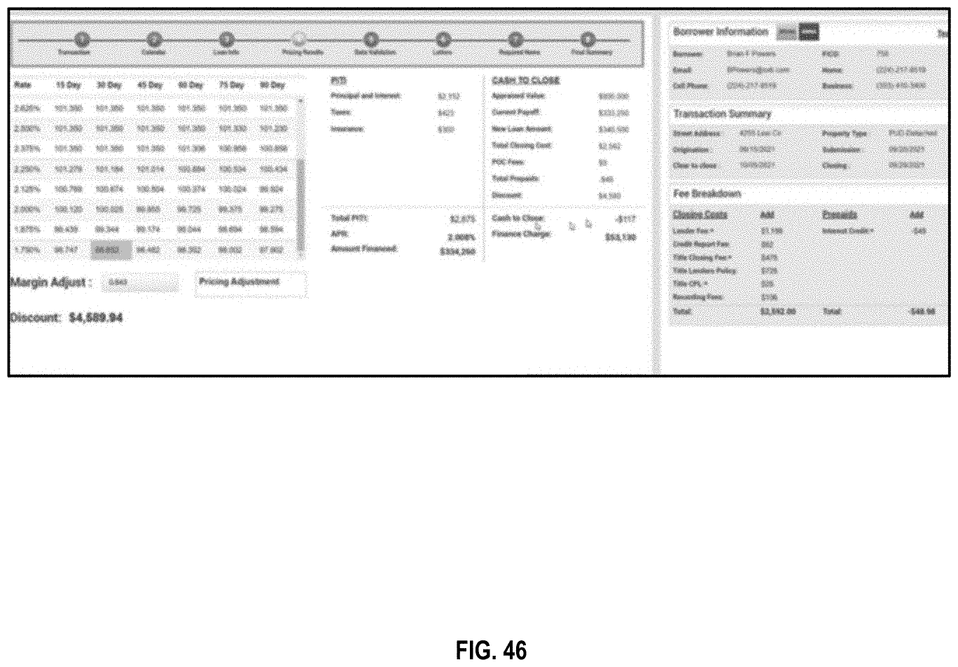

An embodiment of the amortization schedule is shown in FIG. 44. Various calculation are performed by the system as shown in FIG. 45 and a fee detail as shown in FIG. 46 may be provided. The Fee details in the right-hand Fee Breakdown is flowing based on the fee decided by the system administrator. The loan officer can add or remove fee at this stage of the loan. In many configurations, a pdf is generated which may be sent to the borrow to show the pricing and fee details.

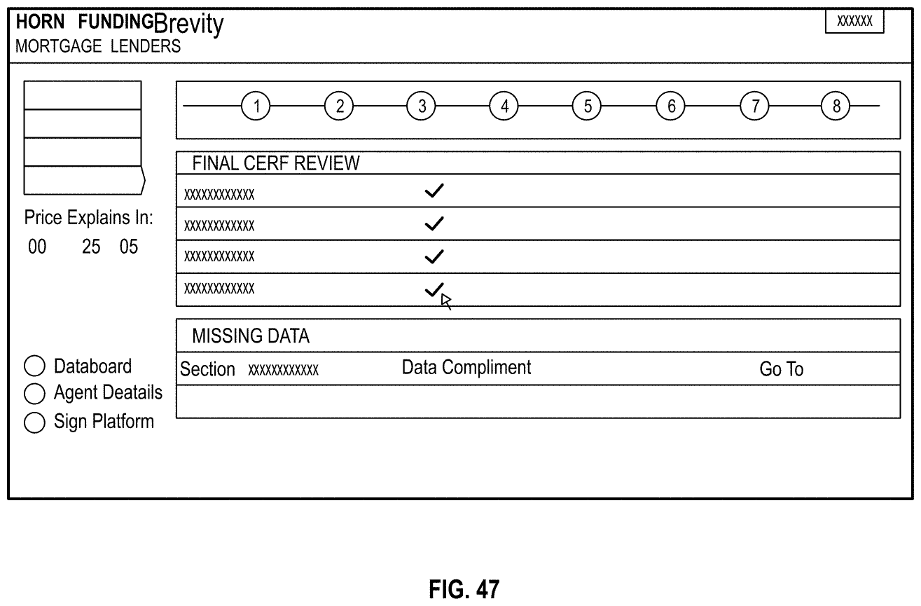

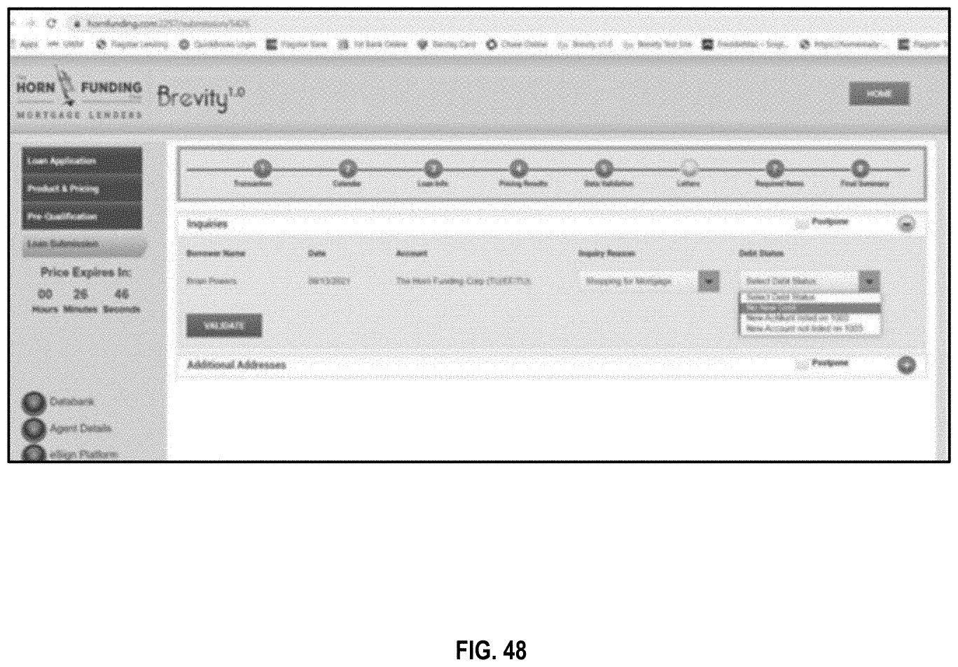

Once the necessary portion of the loan preparation are complete, the loan officer may enter a data validation screen. FIG. 47 shows the Data validation screen, where a final review is done based on the documents provided is the application meeting CERF criteria. The loan officer can see any Missing data (If loan misses any data to be filled will be shown in this section).

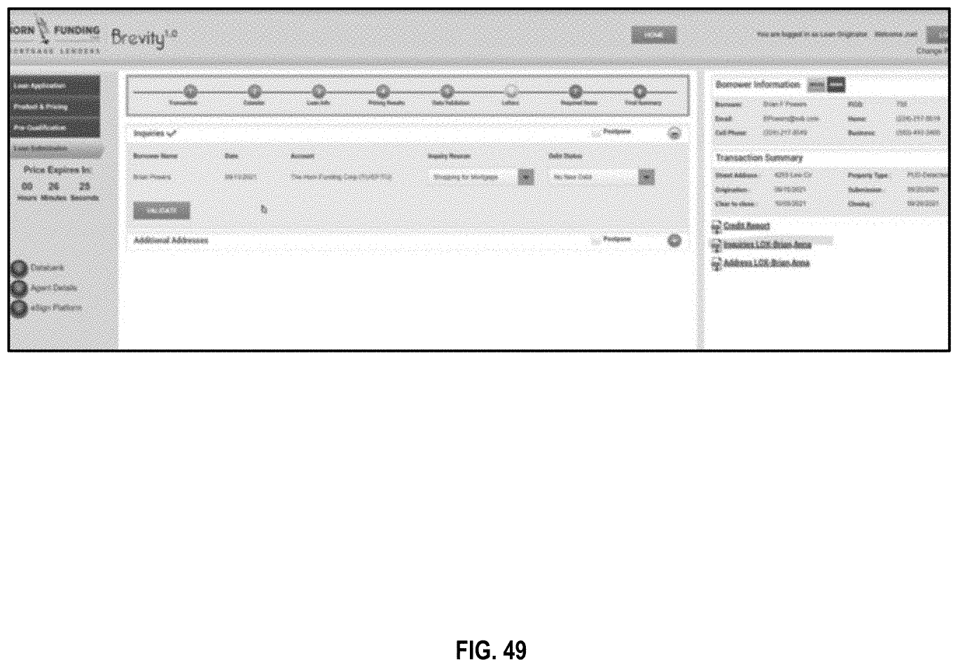

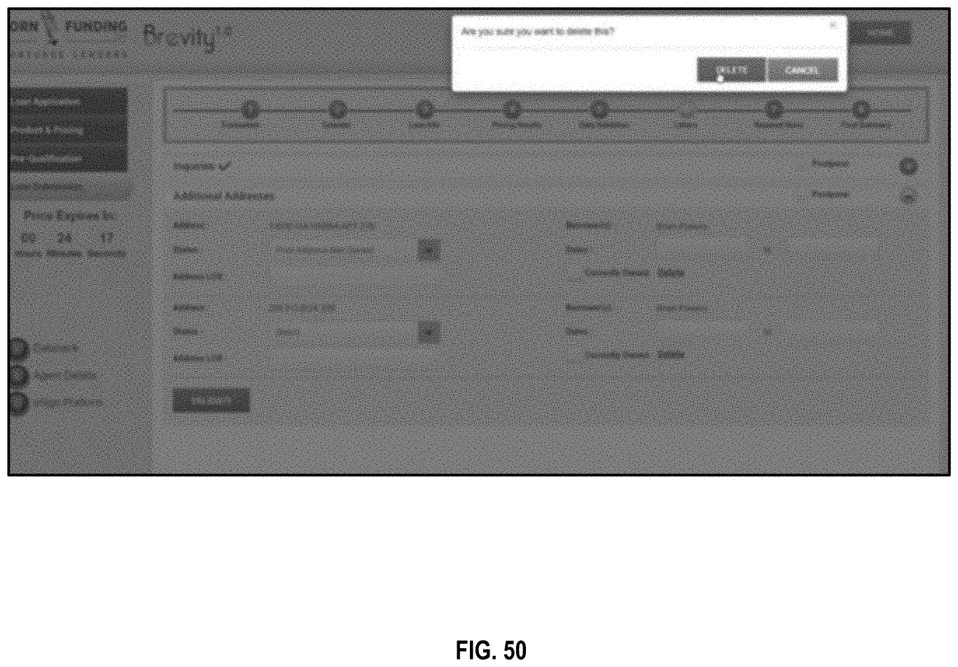

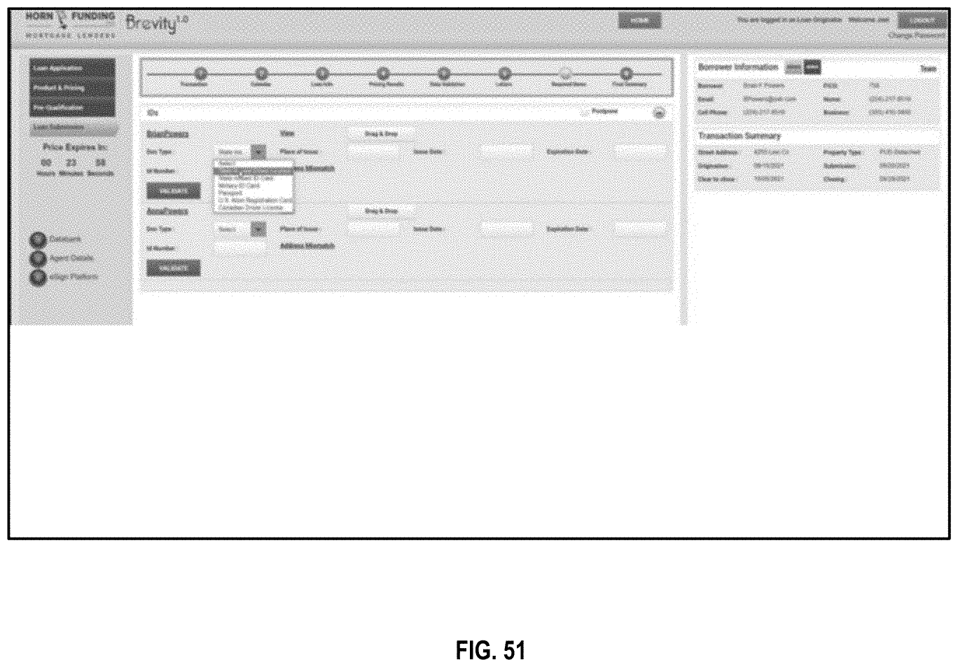

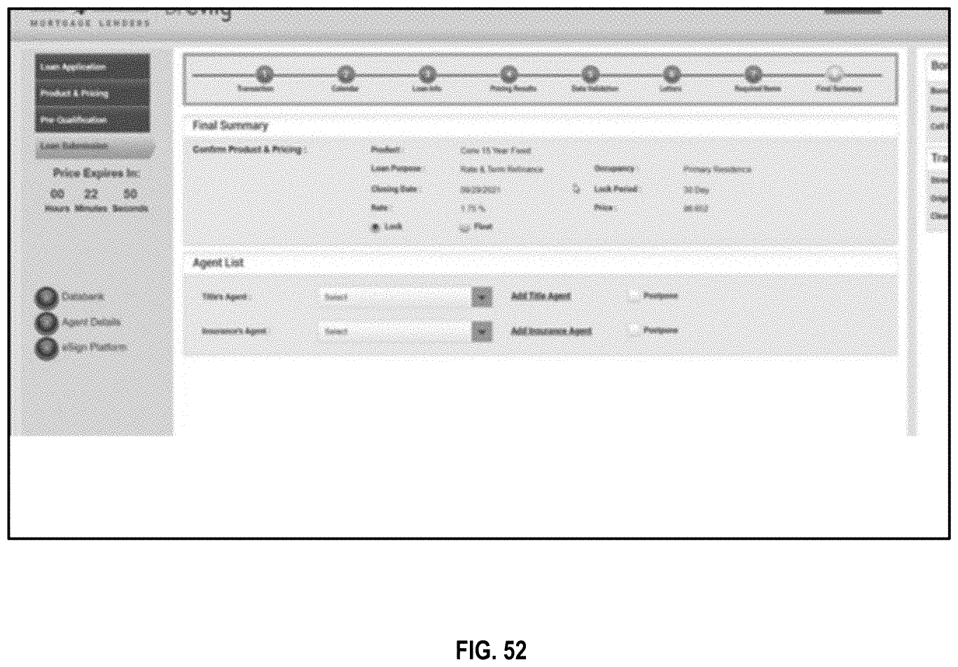

Additionally, the Brevity system may include a letters screen as shown in FIG. 48. An inquiries letter may be created to define why the credit check was done on the borrower. Once the Inquiry reason is filled the letter is generated which is displayed on the borrower information which the borrower must sign. In FIG. 49, if the borrower used multiple address that is mentioned in Credit report (if there is change of address in 24 months period—the reasoning needs to be given to Underwriter). FIG. 50 shows an additional interface whereby a record may be deleted. Additional as shown in FIG. 51 a required items screen may be included in the Brevity system that provides for the upload of borrower ids. FIG. 52 shows the final summary screen for Brevity. Through this interface, the loan officer reconfirms all the borrower details correct, Pricing details are correct. Through the Agent List: The Borrower fills all the agents involved and this flows in the complete loan on the left nav “Agent Details”. Finally, if the loan officer is not aware of agent on the loan they can select “Postpone” check mark which creates item for LO to be filled later. Once all the information is filled the loan officer click on Submit.

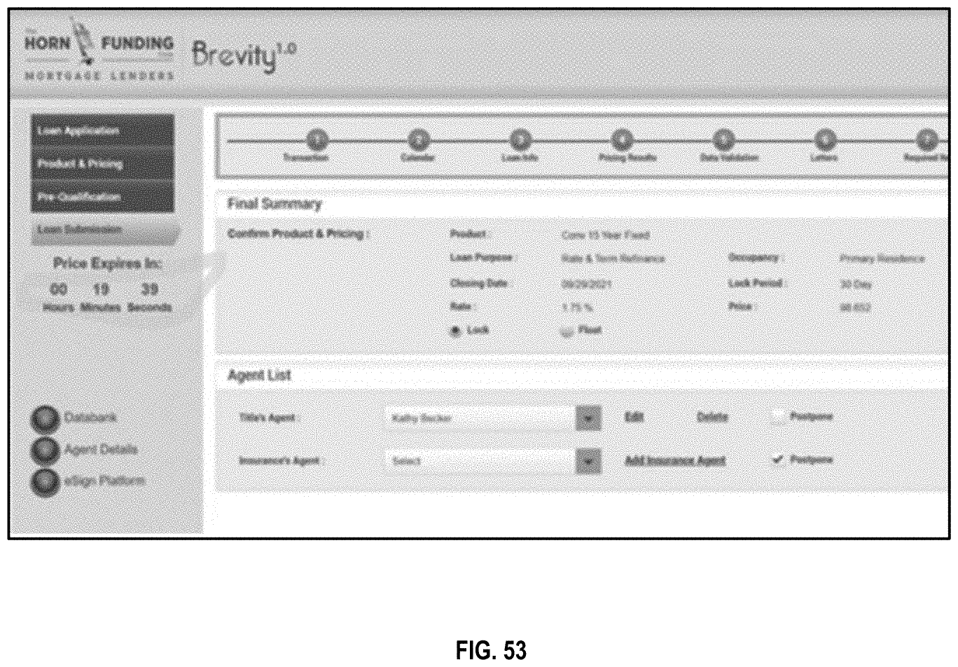

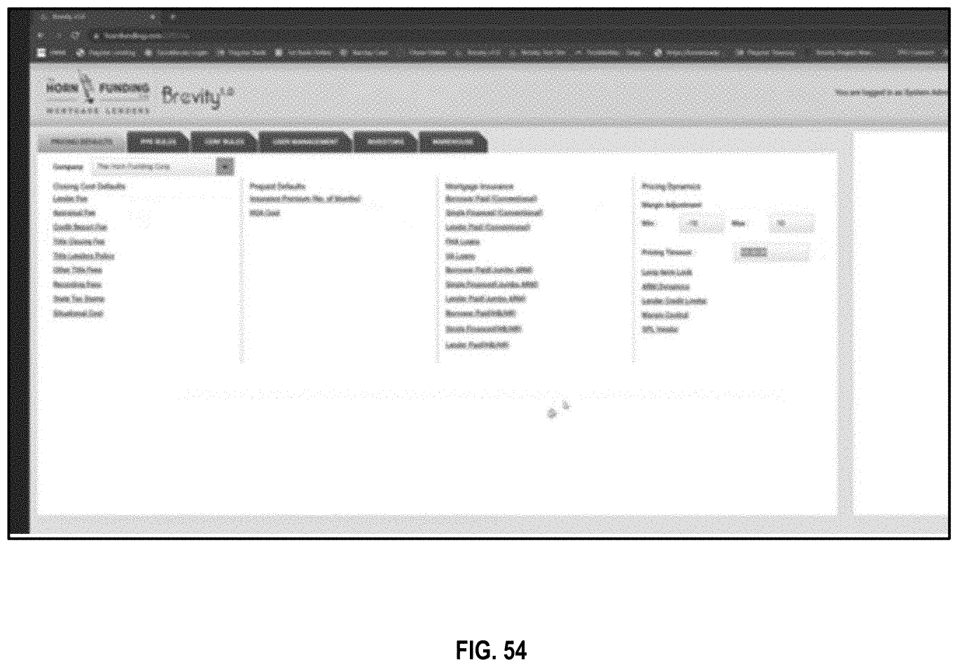

In some scenarios, pricing timeouts may be included in the Brevity system. When the loan officer is working on the Loan to submit after selecting the pricing will have defined amount of time to finish as the pricing may vary if the market is volatile. If loan officer is not able to finish in the defined time must select the pricing once again. FIG. 53 shows a pricing timeout interface. FIG. 54 shows how the pricing dynamics may be defined by a system administrator. When a new Loan is submitted in Brevity the Global manager and packaging manager receives email that a new loan is submitted based on the setting defined in “User Management” Tab under System Administration.

In many embodiments, once the Loan is submitted the Loan moves from Loan Prospects to Active Loan tab. Additionally, the Loan Flow may be selected when the Loan is selected from “Active Loans Tab”. Once a Loan is selected the internal workflow is triggered for active loan. A game plan view may be displayed at this point. The game plan is basically, the Date schedule shared between all the users it shows the historical data of what is already completed and what is more required to be done. In many configurations, the loan officer does not have the ability to change the dates on the game plan but packaging manager can update the dates. The loan officer may additionally view the borrower data entered in the loan application on the right-hand side of the game plan

Finally, when the loan is complete, the loan may move to clear to close. When the Packaging manager completes all the steps and loan moves towards Clear to close the clear to close tab is enabled. Additionally, in some configurations a Pricing Profile lock may be included. The snapshot of the pricing profile of the Loan will be therefore created.

The above description provides numerous details on how the system functions from a loan officer point of view.

In many embodiments, the creation of a game plan data structure and associated module that organizes and transfers data between the various users and automatically limits the functionality they can utilize and the information they interact with leads to better performance of the computing system. When the game plan is accessed by users with different access credentials the system automatically limits access and functionality for that user while still creating a complete set of documents for use in the origination and loan procedure. Additionally, the system provides automatic prompts and safe guards to continue user processes and add efficiencies to the user and computing processes.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

In various instances, parts of the method may be implemented in modules, subroutines, or other computing structures. In many embodiments, the method and software embodying the method may be recorded on a fixed tangible medium.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof. In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

1. A computing system for transforming and improving the processing of information and records data related to real property loans, the system comprising:
a Game Plan module, the Game Plan module including code fixed in a tangible medium, the game plan module including code for data fields, the data fields grouped according to a loan officer and packaging manager, the Game Plan module including code for a scheduling system for scheduling activities related to the data fields, the Game Plan further including code for presenting customized interfaces to the loan officer and the packaging manager according to the activities for collecting information in the data fields, and including code for transforming the information in the data fields in order to prepare them for loan processing for a location of real property, upon advancement by the loan officer and the packaging manager.

2. The system of claim 1, further comprising a Rules Engine module, the Rules Engine module including code fixed in a tangible medium for modifying ability of the loan officer and the packaging manager to perform the advancement.

3. The system of claim 2, wherein the customized interfaces include an active loan interface and a prospective loan interface for the loan officer.

4. The system of claim 3, wherein the customized interfaces include an active loan interface and a prospective loan interface for the packaging manager.

5. The system of claim 4, wherein the Rules Engine module includes a pricing engine that defines the fee on services.

6. The system of claim 5, wherein the services include a lender fee and an appraisal fee.

7. The system of claim 6, wherein the Rules Engine module includes a calendar engine, which provides for needed response times for the collection of portions of the information.

8. The system of claim 7, wherein the Rules Engine module includes PPE rules (product pricing engine) and CERF rules (credit, employment, rules, funds) and the PPE rules include basis eligibility rules for the borrower and the CERF rules include credit check rules, employment verification rules, pricing rules, and funds verification.

9. The system of claim 8, further comprising a global manager interface, the global manager interface, providing a plurality of system views, include a loan officer view, a packaging manager view, a loan administrator view, and closer/funder view.

10. The system of claim 9, wherein each of the plurality of system views is separately accessible by a corresponding user.

11. A method for transforming and improving the processing of information and records data related to real property loans, the method comprising:
providing a Game Plan module, the Game Plan module including code fixed in a tangible medium, the game plan module including code for data fields, the data fields grouped according to a loan officer and packaging office;
scheduling activities related to the data fields, the Game Plan module including code for a scheduling system performing the scheduling; presenting customized interfaces to the loan officer and the packaging manager according to the activities for collecting information in the data fields;
transforming the information in the data fields in order to prepare them for loan processing for a location of real property, upon advancement by the loan officer and the packaging manager.

12. The method of claim 11, further comprising modifying ability of the loan officer and the packaging manager to perform the advancement with a Rules Engine module.

13. The method of claim 12, wherein the customized interfaces include an active loan interface and a prospective loan interface for the loan officer.

14. The method of claim 13, wherein the customized interfaces include an active loan interface and a prospective loan interface for the packaging manager.

15. The method of claim 14, wherein the Rules Engine module includes a pricing engine that defines the fee on services.

16. The method of claim 15, wherein the services include a lender fee and an appraisal fee.

17. The method of claim 16, wherein the Rules Engine module includes a calendar engine, which provides for needed response times for the collection of portions of the information.

18. The method of claim 17, wherein the Rules Engine module includes PPE rules (product pricing engine) and CERF rules (credit, employment, rules, funds) and the PPE rules include basis eligibility rules for the borrower and the CERF rules include credit check rules, employment verification rules, pricing rules, and funds verification.

19. The method of claim 18, further comprising providing a global manager interface, the global manager interface providing a plurality of system views, include a loan officer view, a packaging manager view, a loan administrator view, and closer/funder view.

20. The method of claim 19, wherein each of the plurality of system views is separately accessible by a corresponding user.

21. A non-transitory digital storage medium having a computer program stored thereon to perform a method for transforming and improving the processing of information and records data related to real property loans, the method comprising:
providing a Game Plan module, the Game Plan module including code fixed in a tangible medium, the game plan module including code for data fields, the data fields grouped according to a loan officer and packaging office;
scheduling activities related to the data fields, the Game Plan module including code for a scheduling system performing the scheduling; presenting customized interfaces to the loan officer and the packaging manager according to the activities for collecting information in the data fields;
transforming the information in the data fields in order to prepare them for loan processing for a location of real property, upon advancement by the loan officer and the packaging manager.

22. The method of claim 21, further comprising modifying ability of the loan officer and the packaging manager to perform the advancement with a Rules Engine module.
